(19) United States
(12) Patent Application Publication
(10) Pub. No.: US 2019/0102669 A1
(43) Pub. Date: Apr. 4, 2019

(54) GLOBAL AND LOCAL TIME-STEP DETERMINATION SCHEMES FOR NEURAL NETWORKS

(71) Applicant: Intel Corporation, Santa Clara, CA (US)

(72) Inventors: Gregory K. Chen, Portland, OR (US); Kshitij Bhardwaj, New York, NY (US); Raghavan Kumar, Hillsboro, OR (US); Huseyin E. Sumbul, Portland, OR (US); Phil Knag, Portland, OR (US); Ram K. Krishnamurthy, Portland, OR (US); Himanshu Kaul, Portland, OR (US)

(21) Appl. No.: 15/721,653

(22) Filed: Sep. 29, 2017

(51) Int. Cl. G06N 3/04; G06N 3/063

(52) U.S. Cl. CPC G06N 3/049; G06N 3/063; G06N 3/0454

(57) ABSTRACT

In one embodiment, a processor comprises a first neuromorphic core to implement a plurality of neural units of a neural network, the first neuromorphic core comprising a memory to store a current time-step of the first neuromorphic core; and a controller to track current time-steps of neighboring neuromorphic cores that receive spikes from or provide spikes to the first neuromorphic core; and control the current time-step of the first neuromorphic core based on the current time-steps of the neighboring neuromorphic cores.

### FIELD

The present disclosure relates in general to the field of computer development, and more specifically, to global and local time-step determination schemes for neural networks.

### BACKGROUND

A neural network may include a group of neural units loosely modeled after the structure of a biological brain which includes large clusters of neurons connected by synapses. In a neural network, neural units are connected to other neural units via links which may be excitatory or inhibitory in their effect on the activation state of connected neural units. A neural unit may perform a function utilizing the values of its inputs to update a membrane potential of the neural unit. A neural unit may propagate a spike signal to connected neural units when a threshold associated with the neural unit is surpassed. A neural network may be trained or otherwise adapted to perform various data processing tasks, such as computer vision tasks, speech recognition tasks, or other suitable computing tasks.

### BRIEF DESCRIPTION OF THE DRAWINGS

FIG. 1 illustrates a block diagram of a processor comprising a network on a chip (NoC) system that may implement a neural network in accordance with certain embodiments.

FIG. 2 illustrates an example portion of a neural network in accordance with certain embodiments.

FIG. 3A illustrates an example progression of a membrane potential of a neural unit in accordance with certain embodiments.

FIG. 3B illustrates an example progression of a membrane potential of a neural unit of an event driven and time hopping neural network in accordance with certain embodiments.

FIG. 4A illustrates an example progression of a membrane potential of an integrate and fire neural unit in accordance with certain embodiments.

FIG. 4B illustrates an example progression of a membrane potential of a leaky-integrate and fire neural unit in accordance with certain embodiments.

FIG. 5 illustrates communication of local next spike times across an NoC in accordance with certain embodiments.

FIG. 6 illustrates communication of a global next spike time across an NoC in accordance with certain embodiments.

FIG. 7 illustrates logic for calculating a local next spike time in accordance with certain embodiments.

FIG. 8 illustrates an example flow for calculating a next spike time and receiving a global spike time in accordance with certain embodiments.

FIGS. 9A and 9B illustrate allowable relative time-steps between two connected neuron cores for a localized time-step determination scheme in accordance with certain embodiments.

FIGS. 10A-10D illustrate a sequence of connection states between multiple cores in accordance with certain embodiments.

FIG. 11 illustrates an example neuron core controller 1100 for tracking time-steps of neuromorphic cores in accordance with certain embodiments.

FIG. 12 illustrates a neuromorphic core 1200 in accordance with certain embodiments.

FIG. 13 illustrates a flow for processing spikes of various time-steps and incrementing a time-step of a neuromorphic core in accordance with certain embodiments.

FIG. 14A is a block diagram illustrating both an exemplary in-order pipeline and an exemplary register renaming, out-of-order issue/execution pipeline in accordance with certain embodiments.

FIG. 14B is a block diagram illustrating both an exemplary embodiment of an in-order architecture core and an exemplary register renaming, out-of-order issue/execution architecture core to be included in a processor in accordance with certain embodiments;

FIGS. 15A-B illustrate a block diagram of a more specific exemplary in-order core architecture, which core would be one of several logic blocks (potentially including other cores of the same type and/or different types) in a chip in accordance with certain embodiments;

FIG. 16 is a block diagram of a processor that may have more than one core, may have an integrated memory controller, and may have integrated graphics in accordance with certain embodiments;

FIGS. 17, 18, 19, and 20 are block diagrams of exemplary computer architectures in accordance with certain embodiments; and

FIG. 21 is a block diagram contrasting the use of a software instruction converter to convert binary instructions in a source instruction set to binary instructions in a target instruction set in accordance with certain embodiments.

Like reference numbers and designations in the various drawings indicate like elements.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present disclosure. It will be apparent, however, to one skilled in the art that these specific details need not be employed to practice the present disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present disclosure.

Although the following embodiments may be described with reference to specific integrated circuits, such as computing platforms or microprocessors, other embodiments are applicable to other types of integrated circuits and logic devices. Similar techniques and teachings of embodiments described herein may be applied to other types of circuits or semiconductor devices. For example, the disclosed embodiments may be used in various devices, such as server computer systems, desktop computer systems, handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatuses, methods, and systems described herein are not limited to physical computing devices, but may also relate to software optimizations for energy conservation and efficiency.

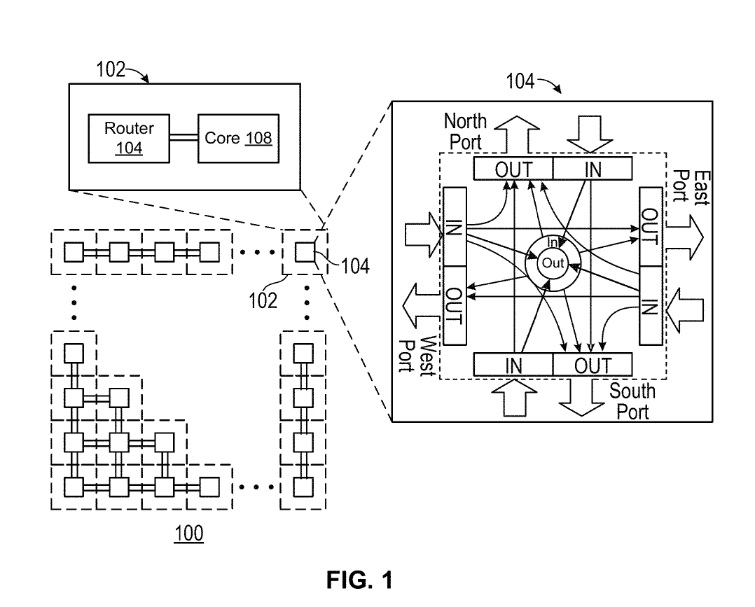

FIG. 1 illustrates a block diagram of a processor 100 comprising a network on a chip (NoC) system that may implement a neural network in accordance with certain embodiments. The processor 100 may include any processor or processing device, such as a microprocessor, an embedded processor, a digital signal processor (DSP), a network processor, a handheld processor, an application processor, a co-processor, an SoC, or other device to execute code. In a particular embodiment, processor 100 is implemented on a single die.

In the embodiment depicted, processor 100 includes a plurality of network elements 102 arranged in a grid network and coupled to each other with bi-directional links. However, an NoC in accordance with various embodiments of the present disclosure may be applied to any suitable network topologies (e.g., a hierarchical network or a ring network), sizes, bus widths, and processes. In the embodiment depicted, each network element 102 includes a router 104 and a core 108 (which in some embodiments may be a neuromorphic core), however in other embodiments, multiple cores from different network elements 102 may share a single router 104. The routers 104 may be communicatively linked with one another in a network, such as a packet-switched network and/or a circuit-switched network, thus enabling communication between components (such as cores, storage elements, or other logic blocks) of the NoC that are connected to the routers. In the embodiment depicted, each router 104 is communicatively coupled to its own core 108. In various embodiments, each router 104 may be communicatively coupled to multiple cores 108 (or other processing elements or logic blocks). As used herein, a reference to a core may also apply to other embodiments where a different logic block is used in place of a core. For example, various logic blocks may comprise a hardware accelerator (e.g., a graphics accelerator, multimedia accelerator, or video encode/decode accelerator), I/O block, memory controller, or other suitable fixed function logic. The processor 100 may include any number of processing elements or other logic blocks that may be symmetric or asymmetric. For example, the cores 108 of processor 100 may include asymmetric cores or symmetric cores. Processor 100 may include logic to operate as either or both of a packet-switched network and a circuit-switched network to provide intra-die communication.

In particular embodiments, packets may be communicated among the various routers 104 using resources of a packet-switched network. That is, the packet-switched network may provide communication between the routers (and their associated cores). The packets may include a control portion and a data portion. The control portion may include a destination address of the packet, and the data portion may contain the specific data to be communicated on the processor 100. For example, the control portion may include a destination address that corresponds to one of the network elements or cores of the die. In some embodiments, the packet-switched network includes buffering logic because a dedicated path is not assured from a source to a destination and so a packet may need to be stopped temporarily if two or more packets need to traverse the same link or interconnect. As an example, the packets may be buffered (e.g., by flip flops) at each of the respective routers as the packet travels from a source to a destination. In other embodiments, the buffering logic may be omitted and packets may be dropped when collision occurs. The packets may be received, transmitted, and processed by the routers 104. The packet-switched network may use point-to-point communication between neighboring routers. The control portions of the packets may be transferred between routers based on a packet clock, such as a 4 GHz clock. The data portion of the packets may be transferred between routers based on a similar clock, such as a 4 GHz clock.

In an embodiment, routers of processor 100 may be variously provided in two networks or communicate in two networks, such as a packet-switched network and a circuit-switched network. Such a communication approach may be termed a hybrid packet/circuit-switched network. In such embodiments, packets may be variously communicated among the various routers 104 using resources of the packet-switched network and the circuit-switched network. In order to transmit a single data packet, the circuit-switched network may allocate an entire path, whereas the packet-switched network may allocate only a single segment (or interconnect). In some embodiments, the packet-switched network may be utilized to reserve resources of the circuit-switched network for transmission of data between routers 104.

Router 104 may include a plurality of port sets to variously couple to and communicate with adjoining network elements 102. For example, circuit-switched and/or packet-switched signals may be communicated through these port sets. Port sets of router 104 may be logically divided, for example, according to the direction of adjoining network elements and/or the direction of traffic exchanges with such elements. For example, router 104 may include a north port set with input (“IN”) and output (“OUT”) ports configured to (respectively) receive communications from and send communications to a network element 102 located in a “north” direction with respect to router 104. Additionally or alternatively, router 104 may include similar port sets to interface with network elements located to the south, west, east, or other direction. In the embodiment depicted, router 104 is configured for X first, Y second routing wherein data moves first in the East/West direction and then in the North/South direction. In other embodiments, any suitable routing scheme may be used.

In various embodiments, router 104 further comprises another port set comprising an input port and an output port configured to receive and send (respectively) communications from and to another agent of the network. In the embodiment depicted, this port set is shown at the center of router 104. In one embodiment, these ports are for communications with logic that is adjacent to, is in communication with, or is otherwise associated with router 104, such as logic of a “local” core 108. Herein, this port set will be referred to as a “core port set,” though it may interface with logic other than a core in some implementations. In various embodiments, the core port set may interface with multiple cores (e.g., when multiple cores share a single router) or the router 104 may include multiple core port sets that each interface with a respective core. In another embodiment, this port set is for communications with a network element which is in a next level of a network hierarchy higher than that of router 104. In one embodiment, the east and west directional links are on one metal layer, the north and south directional links on a second metal layer, and the core links on a third metal layer. In an embodiment, router 104 includes crossbar switching and arbitration logic to provide the paths of inter-port communication such as that shown in FIG. 1. Logic (such as core 108) in each network element may have a unique clock and/or voltage or may share a clock and/or voltage with one or more other components of the NoC.

In particular embodiments, a core 108 of a network element may comprise a neuromorphic core including one or more neural units. A processor may include one or more neuromorphic cores. In various embodiments, each neuromorphic core may comprise one or more computational logic blocks that are time-multiplexed across the neural units of the neuromorphic core. A computational logic block may be operable to perform various calculations for a neural unit, such as updating the membrane potential of the neural unit, determining whether the membrane potential exceeds a threshold, and/or other operations associated with a neural unit. Herein, reference herein to a neural unit may refer to logic used to implement a neuron of a neural network. Such logic may include storage for one or more parameters associated with the neuron. In some embodiments, the logic used to implement a neuron may overlap with the logic used to implement one or more other neurons (in some embodiments a neural unit corresponding to a neuron may share computational logic with other neural units corresponding to other neurons and control signals may determine which neural unit is currently using the logic for processing).

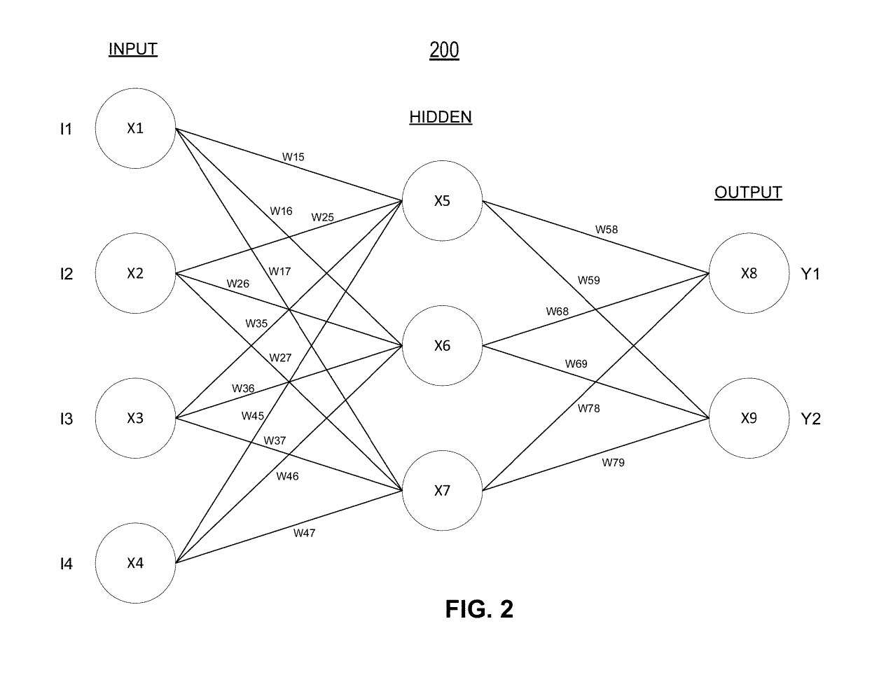

FIG. 2 illustrates an example portion of a neural network 200 in accordance with certain embodiments. The neural network 200 includes neural units X1-X9. Neural units X1-X4 are input neural units that respectively receive primary inputs I1-I4 (which may be held constant while the neural network 200 processes an output). Any suitable primary inputs may be used. As one example, when neural network 200 performs image processing, a primary input value may be the value of a pixel from an image (and the value of the primary input may stay constant while the image is processed). As another example, when neural network 200 performs speech processing the primary input value applied to a particular input neural unit may change over time based on changes to the input speech.

While a specific topology and connectivity scheme is shown in FIG. 2, the teachings of the present disclosure may be used in neural networks having any suitable topology and/or connectivity. For example, a neural network may be a feedforward neural network, a recurrent network, or other neural network with any suitable connectivity between neural units. In the embodiment depicted, each link between two neural units has a synapse weight indicating the strength of the relationship between the two neural units. The synapse weights are depicted as WXY, where X indicates the pre-synaptic neural unit and Y indicates the post-synaptic neural unit. Links between the neural units may be excitatory or inhibitory in their effect on the activation state of connected neural units. For example, a spike that propagates from X1 to X5 may increase or decrease the membrane potential of X5 depending on the value of W15. In various embodiments, the connections may be directed or undirected.

In general, during each time-step of a neural network, a neural unit may receive any suitable inputs, such as a bias value or one or more input spikes from one or more of the neural units that are connected via respective synapses to the neural unit (this set of neural units are referred to as fan-in neural units of the neural unit). The bias value applied to a neural unit may be a function of a primary input applied to an input neural unit and/or some other value applied to a neural unit (e.g., a constant value that may be adjusted during training or other operation of the neural network). In various embodiments, each neural unit may be associated with its own bias value or a bias value could be applied to multiple neural units.

The neural unit may perform a function utilizing the values of its inputs and its current membrane potential. For example, the inputs may be added to the current membrane potential of the neural unit to generate an updated membrane potential. As another example, a non-linear function, such as a sigmoid transfer function, may be applied to the inputs and the current membrane potential. Any other suitable function may be used. The neural unit then updates its membrane potential based on the output of the function. When the membrane potential of a neural unit exceeds a threshold, the neural unit may send spikes to each of its fan-out neural units (i.e., the neural units connected to the output of the spiking neural unit). For example, when X1 spikes, the spikes may be propagated to X5, X6, and X7. As another example, when X5 spikes, the spikes may be propagated to X8 and X9 (and in some embodiments to X1, X2, X3, and X4). In various embodiments, when a neural unit spikes, the spike may be propagated to one or more connected neural units residing on the same neuromorphic core and/or packetized and transferred through one or more routers 104 to a neuromorphic core that includes one or more of the spiking neural unit's fan-out neural units. The neural units that a spike is sent to when a particular neural unit spikes are referred to as the neural unit's fan-out neural units.

In a particular embodiment, one or more memory arrays may comprise memory cells that store the synapse weights, membrane potentials, thresholds, outputs (e.g., the number of times that a neural unit has spiked), bias amounts, or other values used during operation of the neural network 200. The number of bits used for each of these values may vary depending on the implementation. In the examples illustrated below, specific bit lengths may be described with respect to particular values, but in other embodiments any suitable bit lengths may be used. Any suitable volatile and/or non-volatile memory may be used to implement the memory arrays.

In a particular embodiment, neural network 200 is a spiking neural network (SNN) including a plurality of neural units that each track their respective membrane potentials over a number of time-steps. A membrane potential is updated for each time-step by adjusting the membrane potential of the previous time-step with a bias term, leakage term (e.g., if the neural units are leaky integrate and fire neural units), and/or contributions for incoming spikes. The transfer function applied to the result may generate a binary output.

Although the degree of sparsity in various SNNs for typical pattern recognition workloads is very high (for example, 5% of the entire neural unit population may spike for a particular input pattern), the amount of energy expended in memory access for updating neural states (even in the absence of input spikes) is significant. For example, memory access for fetching synapse weights and updating neural unit states may be the primary component of the total energy consumption of a neuromorphic core. In neural networks (e.g., SNNs) with sparse activity, many neural unit state updates perform very little useful computation.

In various embodiments of the present disclosure, a global time-step communication scheme for an event-driven neural network leveraging time-hopping computation is provided. Various embodiments described herein provide systems and methods for reducing the number of memory accesses without comprising the accuracy or performance of a computing workload of a neuromorphic computing platform. In particular embodiments, the neural network computes neural unit state changes only on time-steps where spiking events are being processed (i.e., active time-steps). When a neural unit's membrane potential is updated, the contributions to the membrane potential due to time-steps in which the state of the neural unit was not updated (i.e., idle time-steps) are determined and aggregated with contributions to the membrane potential due to the active time-step. The neural unit may then remain idle (i.e., skip membrane potential updates) until the next active time-step, thus improving performance while reducing memory accesses to minimize energy consumption (due to the skipping of memory accesses for idle time-steps). The next active time-step for a neural network (or a sub-portion thereof) may be determined at a central location and communicated to various neuromorphic cores of the neural network.

The event driven, time hopping neural network may be used to perform any suitable workloads, such as the sparse encoding of input images or other suitable workloads (e.g., workloads in which the frequency of spikes is relatively low). Although various embodiments herein are discussed in the context of SNNs, the concepts of this disclosure may be applied to any suitable neural networks, such as convolutional neural networks or other suitable neural networks.

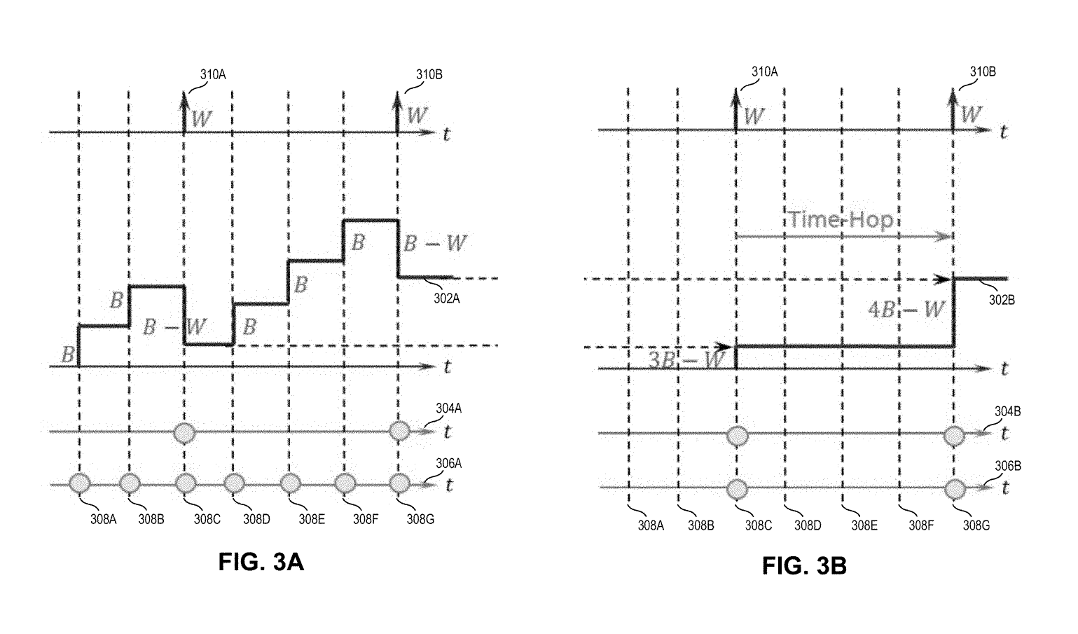

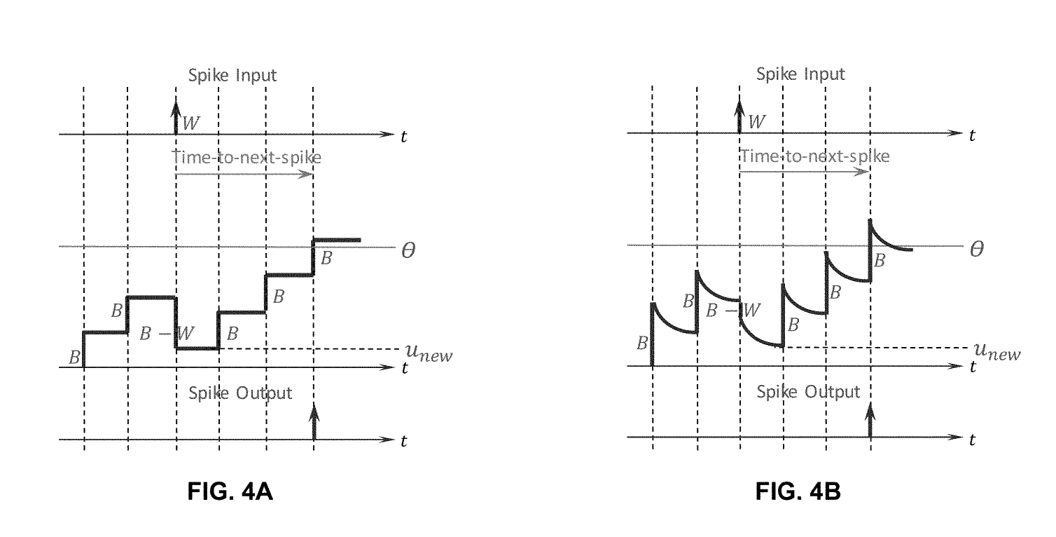

FIG. 3A illustrates an example progression of a membrane potential 302A of a neural unit in accordance with certain embodiments. The progression depicted is based on time-step based neural computations in which a neural unit's membrane potential is updated at each time-step 308. FIG. 3A depicts an example membrane potential progression for an integrate and fire neural unit (with no leakage) with an arbitrary input spike pattern. 304A depicts accesses made to an array storing synapse weights for connections between neural units (“synapse array”) and 306A depicts accesses made to an array storing bias terms for the neural units (“bias array”) and an array storing the current membrane potentials of the neural units (“neural state array”). In various embodiments depicted herein, the membrane potential is simply a sum of the current membrane potential and the inputs to the neural unit, though in other embodiments any suitable function may be used to determine an updated membrane potential.

In various embodiments, the synapse array is stored separately from the bias array and/or the neural state array. In a particular embodiment, the bias and neural state arrays are implemented using a relatively fast memory such as a register file (in which each memory cell is a transistor, a latch, or other suitable structure) while the synapse array is stored using a relatively slower memory (e.g., a static random-access memory (SRAM)) better suited for storing large amounts of information (due to the relatively large number of connections between neural units). However, in various embodiments any suitable memory technologies (e.g., register files, SRAM, dynamic random-access memory (DRAM), flash memory, phase change memory, or other suitable memory) may be used for any of these arrays.

At time-step 308A, the bias array and neural state array are accessed and the membrane potential of the neural unit is increased by a bias term (B) for the neural unit and the updated membrane potential is written back to the neural state array. During the time-step 308A, the other neural units may also be updated (in various embodiments processing logic may be shared among multiple neural units and the neural units may be updated in succession). At time-step 308B, the bias array and neural state array are again accessed and the membrane potential is increased by B. At time-step 308C, an input spike 310A is received. Accordingly, the synapse array is accessed to retrieve the weight of the connection between the neural unit being processed and the neural unit from which the spike was received (or multiple synapse weights if multiple spikes are received). In this example, the spike has a negative effect on the membrane potential (though a spike could alternatively have a positive effect on the membrane potential or no effect on the membrane potential) and the total effect on the potential at time-step 308C is B−W. At time-steps 308D-308F, no input spikes are received, so only the bias array and neural state array are accessed and the bias term is added to the membrane potential at each time-step. At time-step 308G, another input spike 310B is received and thus the synapse array, bias array, and neural state array are accessed to obtain values to update the membrane potential.

In this approach wherein the neural state is updated at each time-step, the membrane potential may be expressed as:

$$u ( t + 1 ) = u ( t ) + B - {\sum }_{i} {W}_{i} \cdot {I}_{i}$$

where u(t+1) equals the membrane potential at the next time-step, u(t) equals the current membrane potential, B is the bias term for the neural unit, and Wᵢ·Iᵢ is the product of a binary indication (i.e., 1 or 0) of whether a particular neural unit i coupled to the neural unit being processed is spiking and the synapse weight of the connection between neural unit i and the neural unit being processed. The summation may be performed over all neural units coupled to the neural unit being processed.

In this example where the neural units are updated at each time-step, the bias array and the neural state array are accessed at each time-step. Such an approach may use excessive energy when input spikes are relatively rare (e.g., for workloads such as sparse encoding of images).

FIG. 3B illustrates an example progression of a membrane potential 302B of a neural unit of an event driven and time hopping neural network in accordance with certain embodiments. The progression depicted is an event driven and time hopping based neural computation in which a neural unit's membrane potential is updated only at active time-steps 308C and 308G in which one or more input spikes are received. As in FIG. 3A, this progression depicts an integrate and fire neural unit (with no leakage) with the same spike pattern and bias input as progression 302A. 304B depicts accesses made to a synapse array and 306B depicts accesses made to a bias array and a neural state array.

In contrast to the approach shown in FIG. 3A, the neural unit skips time-steps 308A and 308B and the bias array and neural state array are not accessed. At time-step 308C, input spike 310A is received. Similar to the progression of FIG. 3A, the synapse array is accessed to retrieve the weight of the connection between the neural unit being processed and the neural unit from which the spike was received (or multiple synapse weights if multiple spikes are received). The neural state array and bias array are also accessed. In addition to identification of synapse weights corresponding to any spikes received, the inputs to the neural unit for the current time-step and any idle time-steps not yet accounted for (e.g., time-steps occurring in between active time-steps) are determined (e.g., via the bias array access or other means). Accordingly, the update to the membrane potential at 308C is calculated as 3*B−W, which includes three bias terms (one for the current time-step and two for the idle time-steps 308A and 308B which were skipped) and the weight of the incoming spike. The neural unit then skips time-steps 308D, 308E, and 308F. At the next active time-step 308G, the membrane potential is again updated based on inputs at each idle time-step and the current time-step, resulting in a change of 4*B−W to the membrane potential.

After each active time-step of FIG. 3B, the membrane potential 302B matches the membrane potential 302A of the same time-step of FIG. 3A. In this example, where the neural units are updated in response to incoming spikes instead of at each time-step, the bias array and the neural state array are only accessed at active time-steps, thus conserving energy and improving processing time while maintaining accurate tracking of the membrane potentials.

In this approach, wherein the neural state is not updated at each time-step and the bias term remains constant from the last time-step processed to the time-step being processed, the membrane potential may be expressed as:

$$u ( t + n ) = u ( t ) + B \cdot n - {\sum }_{i} {W}_{i} \cdot {I}_{i}$$

where u(t+n) equals the membrane potential at the time-step being processed, u(t) equals the membrane potential at the last time-step processed, n is the number of time-steps from the last processed time-step to the time-step being processed, B is the bias term for the neural unit, and Wᵢ·Iᵢ is the product of a binary indication (i.e., 1 or 0) of whether a particular neural unit i coupled to the neural unit being processed is spiking and the synapse weight of the connection between neural unit i and the neural unit being processed. The summation may be performed over all neural units coupled to the neural unit being processed. If the bias is not constant from the last time-step processed to the time-step being processed, the equation may be modified to:

$$u ( t + n ) = u ( t ) + {\sum }_{j = t + 1}^{t + n} {B}_{j}$$

where Bⱼ is the bias term for the neural unit at time-step j.

In various embodiments, after the membrane potential for a neural unit is updated, a determination may be made as to how many time-steps in the future the neural unit is to spike in the absence of any input spikes (i.e., the calculation is made assuming that no input spikes are received by the neural unit prior to the neural unit spiking). With a constant bias B, the number of time-steps until the membrane potential crosses a threshold θ may be determined as follows:

tₙₑₓₜ=(θ−u)/B

where tₙₑₓₜ equals the number of time-steps until the membrane potential crosses the threshold, u equals the membrane potential that was calculated for the current time-step, and B equals the bias term. Though the methodology is not shown here, the number of time-steps until the membrane potential crosses a threshold θ in the absence of input spikes could also be determined in situations where a bias does not remain constant by determining how many time-steps will elapse before the sum of the biases at each time-step plus the current membrane potential will exceed the threshold.

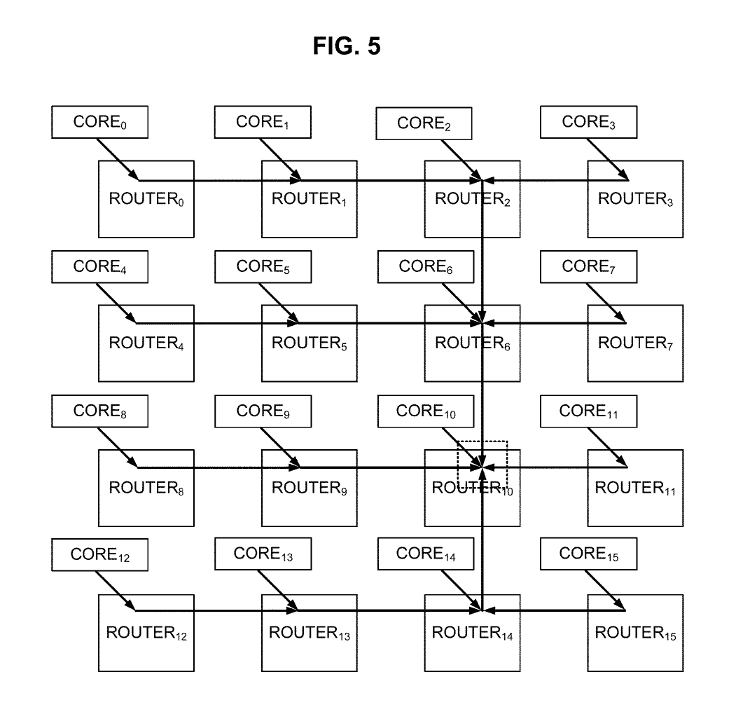

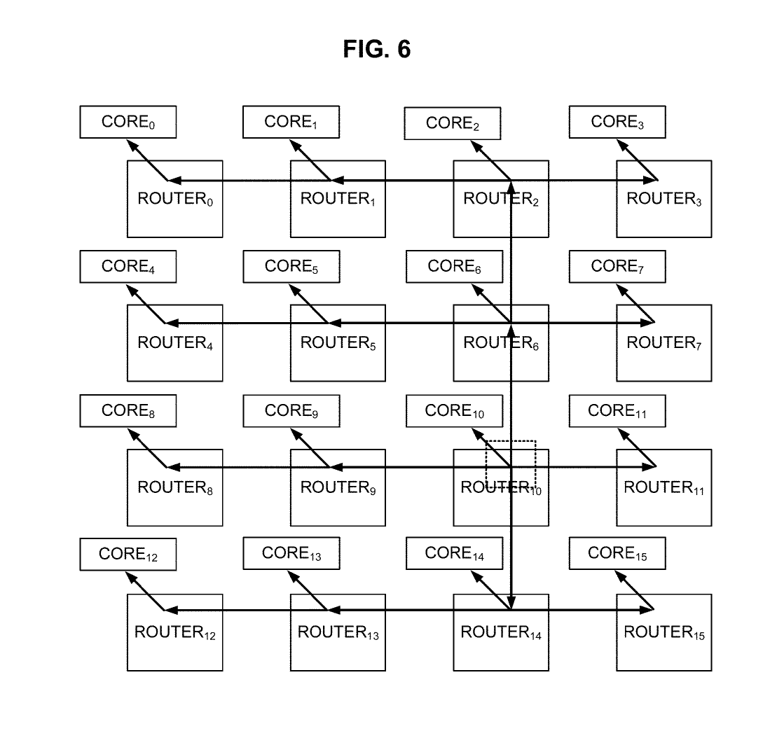

FIG. 4A illustrates an example progression of a membrane potential of an integrate and fire neural unit in accordance with certain embodiments. This progression depicts a time-step based approach similar to that shown in FIG. 4A in which a neural unit's membrane potential is updated at each time-step. FIG. 4A also depicts a threshold θ. Once the membrane potential crosses the threshold, the neural unit may generate a spike and then enter a refractory period configured to prevent the neural unit from immediately spiking again (in some embodiments, the potential may be reset to a particular value when the neural unit spikes). As stated above, the membrane potential in the time-step approach may be calculated as follows:

$$u ( t + 1 ) = u ( t ) + B - {\sum }_{i} {W}_{i}$$

FIG. 4B illustrates an example progression of a membrane potential of a leaky-integrate and fire neural unit in accordance with certain embodiments. In the embodiment depicted, the membrane potential leaks between time-steps and the inputs are scaled based on a time constant τ. The membrane potential may be calculated according to the following equation:

$$u ( t + 1 ) = ( 1 - τ ) \cdot u ( t ) + τ \cdot ( B - {\sum }_{i} {W}_{i} )$$

Similar to the embodiments described above, after the membrane potential for a leaky integrate and fire neural unit is updated, a determination may be made as to how many time-steps in the future the neural unit is to spike in the absence of any input spikes. With a constant bias B, the number of time-steps until the membrane potential crosses a threshold θ may be calculated based on the above equation. In the absence of input spikes, the equation above becomes:

⇒u(t+1)=(1−τ)·u(t)+τ

Similarly:

$$⇒ u ( t + 2 ) = ( 1 - τ ) \cdot u ( t + 1 ) + τ = {( 1 - τ )}^{2} \cdot u ( t ) + τ \cdot B$$

Accordingly:

$$⇒ u ( t + n ) = {( 1 - τ )}^{n} \cdot u ( t ) + τ \cdot B \cdot [ 1 + ( 1 - τ ) + … {( 1 - τ )}^{n - 1} ] = {( 1 - τ )}^{n} \cdot u ( t ) + B \cdot [ 1 - {( 1 - τ )}^{n} ] = {( 1 - τ )}^{n} \cdot ( u ( t ) - B ) + B$$

In order to solve for tₙₑₓₜ (the number of time-steps until the neural unit crosses the threshold θ in the absence of input spikes), u(t+n) is set to θ, and n (shown here as tₙₑₓₜ) is isolated on one side of the equation:

$${t}_{next} = \frac{1}{log ( 1 - τ )}$$

Where u_{new} is the most recently calculated membrane potential for the neural unit. Thus, tₙₑₓₜ may be determined using logic that implements the above calculation. In some embodiments, the logic may be simplified by using an approximation. In a particular embodiment, the equation for u(t+n):

$$u ( t + n ) = {( 1 - τ )}^{n} \cdot ( u ( t ) - B ) + B - τ \cdot {\sum }_{i} {W}_{i}$$

may be approximated as:

$$⇒ u ( t + n ) \approx ( 1 - n τ ) \cdot ( u ( t ) - B ) + B - τ \cdot {\sum }_{i}^{ } {W}_{i}$$

After removing the contribution from the incoming spikes and setting u(t+n) equal to θ, tₙₑₓₜ may be calculated as:

$${t}_{next} = \frac{1}{τ} \cdot ( \frac{{u}_{new} - θ}{{u}_{new} - B} )$$

Accordingly, tₙₑₓₜ may be solved for via logic that implements this approximation. Though the methodology is not shown here, the number of time-steps until the membrane potential crosses a threshold θ in the absence of input spikes could also be determined in situations where a bias does not remain constant by determining how many time-steps will elapse before the sum of the biases at each time-step plus the current membrane potential will exceed the threshold (and factoring in the leakage at each time-step).

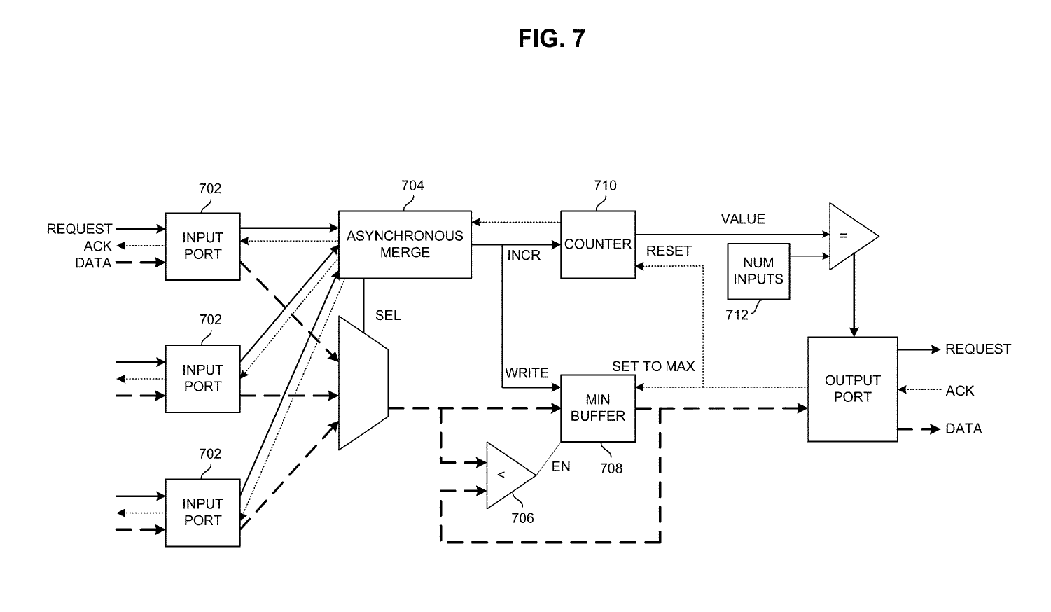

FIG. 5 illustrates communication of local next spike times across an NoC in accordance with certain embodiments. As described above, event-driven SNNs increase efficiency by determining the next time-step when an input spike will occur (i.e., next spike-time) for a particular group of neural units, as opposed to assuming that a spike will occur in the next time-step by default. For example, if neural units are arranged in layers in which each neuron in one layer has directed connections to the neurons of the subsequent layer (e.g., a feed-forward network), the next time-step to be processed for the neural units of a particular layer may be the time-step immediately following the time-step at which any neural unit of the preceding layer is to spike. As another example, in a recurrent network in which each neural unit has a directed connection to every other neural unit, the next time-step to be processed for the neural units is the next time-step at which any of the neural units is to spike. For purposes of explanation, the following discussion will focus on embodiments involving a recurrent network, though the teachings may be adapted to any suitable neural network.

In event-driven SNNs utilizing multiple cores (e.g., each neuromorphic core may include a plurality of neural units of the network), the next time-step in which a spike will occur may be communicated across all of the cores to ensure that spikes are processed in the correct order. The cores may each perform spike integration and thresholding calculations for their neural units independently and in parallel. In an event driven neural network, a core may also determine the next spike time that any neural unit in the core will spike in the absence of input spikes before the calculated speculative next spike time. For example, a next spike time may be calculated for a neural unit using any of the methodologies discussed above or other suitable methodologies.

To resolve spike dependencies and calculate the non-speculative spike time for the neural network (i.e., the next time-step in which a spike will occur in the network), a minimum next spike time is calculated across the cores. In various embodiments, all cores process the spike(s) generated at this non-speculative next spike time. In some systems, each core communicates the next spike time of its neural units to every other core using unicast messages and then each core determines the minimum next spike time of the received spike times and then performs processing at the corresponding time-step. Other systems may rely on a global event queue and controller to coordinate the processed time-steps. In various embodiments of the present disclosure, spike time communication is performed in a low-latency and energy-efficient manner through in-network processing and multi-cast packets.

In the embodiment depicted, each router is coupled to a respective core. For example, router zero is coupled to core zero, router one is coupled to core one, and so on. Each router depicted may have any suitable characteristics of router 104 and each core may have any suitable characteristics of core 108 or other suitable characteristics. For example, the cores may each be neuromorphic cores that implement any suitable number of neural units. In other embodiments, a router may be directly coupled (e.g., through ports of the router) to any number of neuromorphic cores. For example, each router could be directly coupled to four neuromorphic cores.

After a particular time-step is processed, a gather operation may communicate the next spike time for the network to a central entity (e.g., router₁₀ in the embodiment depicted). The central entity may be any suitable processing logic, such as a router, a core, or associated logic. In a particular embodiment, communications between cores and routers during the gather operation may follow a spanning tree having the central entity as its root. Each node of the tree (e.g., a core or a router) may send a communication with a next spike time to its parent node (e.g., router) on the spanning tree.

A local next spike time for a particular router is the minimum next spike time of the next spike times received at that router. A router may receive spike times from each of the cores directly connected to the router (in the embodiment depicted each router is only directly coupled to a single core) as well as one or more next spike times from adjacent routers. The router selects the local next spike time as the minimum of the received next spike times, and forwards this local next spike time to the next router. In the embodiment depicted, the local next spike times of routers 0, 3, 4, 7, 8, 11, 12, and 15 will simply be the next spike time of the respective cores to which the routers are coupled. Router₁ will select the local next spike time from the local next spike time received from router₀ and the next spike time received from core₁. Router₅ will select the local next spike time from the local next spike time received from router₄ and the next spike time received from cores. Router₉ will select the local next spike time from the local next spike time received from routers and the next spike time received from core₉. Router₁₃ will select the local next spike time from the local next spike time received from router₁₂ and the next spike time received from core₁₃. Router₂ will select the local next spike time from the local next spike time received from router₅, the local next spike time received from router₃, and the next spike time received from core₂. Router₆ will select the local next spike time from the local next spike time received from routers the local next spike time received from router₂, the local next spike time received from router, and the next spike time received from core₆. Router₁₄ will select the local next spike time from the local next spike time received from router₁₃, the local next spike time received from routers, and the next spike time received from core₁₄. Finally, router₁₀ (the root node of the spanning tree) will select the global next spike time from the local next spike times received from router₆, router₉, router₁₁, and router₁₄, and the next spike time received from core₁₀. This global next spike time represents the next spike time across the network that a neural unit will spike.

Thus, the leaves of the spanning tree (cores 0 through 15) send their speculative next time-step one hop towards the root of the spanning tree (e.g., in a packet). Each router collects packets from input ports, determines the minimum next spike time among the inputs, and communicates only the minimum next spike time one hop toward the root. This process continues until the root receives the minimum spike time of all the connected cores, at which point the spike time becomes non-speculative and may be communicated to the cores (e.g., using a multicast message) so that the cores may process the time-step indicated by the next spike time (e.g., the neural units of each core may be updated and a new next spike time may be determined).

Using this wave mechanism, instead of sending individual unicast messages from each core to the root, reduces network communication, and improves latency and performance. The topology of the tree that guides the router communications may be pre-calculated or determined on-the-fly using any suitable techniques. In the embodiment depicted, the routers communicate using a tree that follows a dimension order routing scheme, specifically an X first, Y second routing scheme wherein the local next spike times are transported first in the East/West direction and then in the North/South direction. In other embodiments, any suitable routing scheme may be used.

In various embodiments, each router is programmed to know how many input ports it will receive next spike times from and to which output port the local next spike time should be sent. In various embodiments, each communication (e.g., packet) between routers that includes a local next spike time may include a flag bit or opcode indicating that the communication includes a local next spike time. Each router will wait to receive inputs from the specified number of input ports before determining the local next spike time and sending the local next spike time to the next hop.

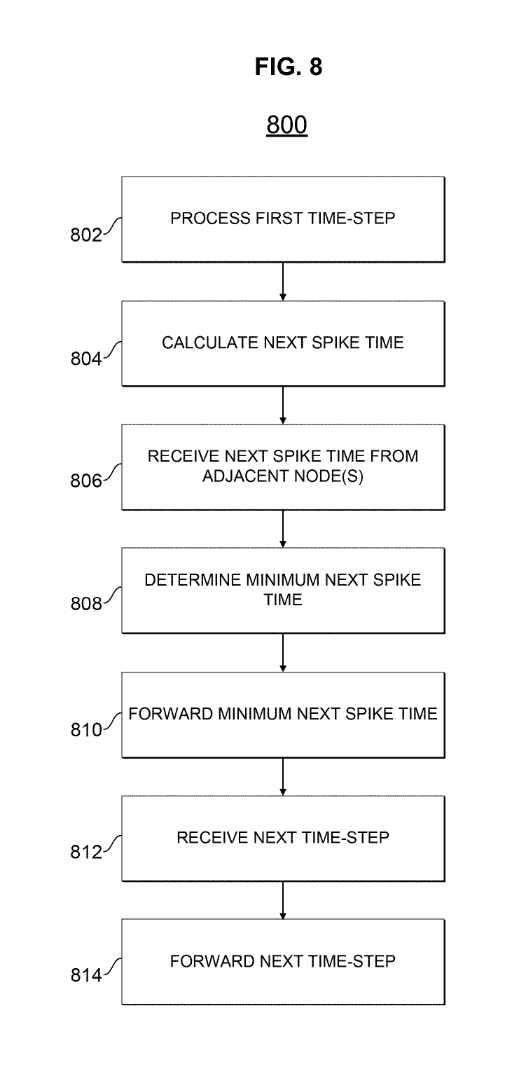

FIG. 6 illustrates communication of a global next spike time across a neural network implemented on an NoC in accordance with certain embodiments. In the embodiment depicted, the central entity (e.g., router₁₀) sends a multi-cast message including the global next spike time to each core of the network. In a particular embodiment, the multicast message follows the same spanning tree (with the communications moving in a reverse direction) as the local next spike times, though in other embodiments the global next spike time may be communicated to the cores using any suitable multicast method. At each branch in the tree, the message may be received via one input port and replicated to multiple output ports. In the multi-cast stage, the global next spike time is communicated to all cores and all cores process neuron activity occurring during this time-step, regardless of their own local speculative next time-step.

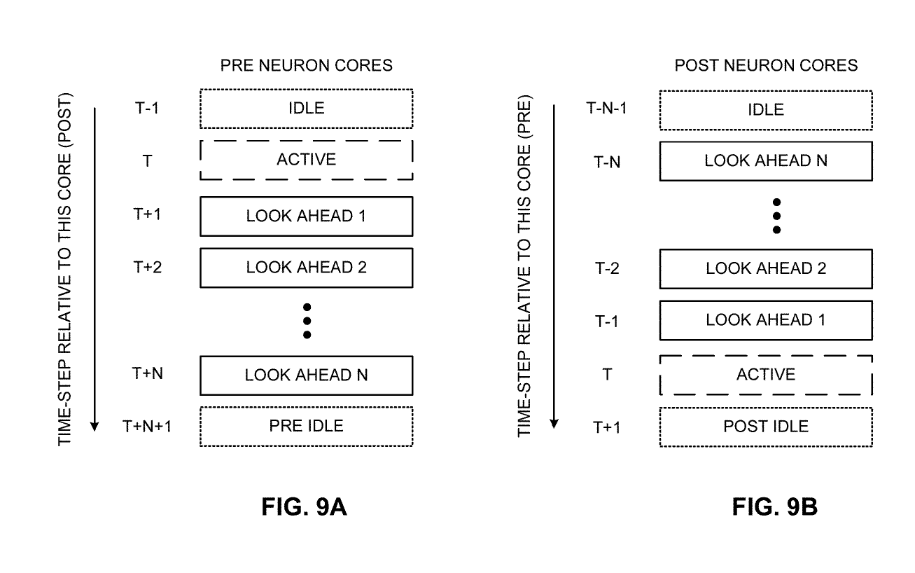

FIG. 7 illustrates logic for calculating a local next spike time in accordance with certain embodiments. In various embodiments, the logic for calculating a local next spike time may be included at any suitable node of the network, such as a core, a router, or a network interface between a core and a router. Similarly, the logic for calculating a global next spike time and transmitting the global next spike time via a multicast message may be included at any suitable node of the network.

In various embodiments, the logic depicted may include circuitry for performing the functions described herein. In a particular embodiment, the logic depicted in FIG. 7 may be located within each router and may communicate with one or more cores (or network interfaces between the cores and the router) and with the router ports (i.e., ports coupled to other routers). The number of input ports that are to receive local next spike times from cores and/or routers and the output port that is to send the computed local next spike time to the next hop may be programmed when the neural network is mapped to hardware of the NoC and remain constant during neural network operation.

The input ports 702 may include any suitable characteristics of the input ports described with respect to FIG. 1. An input port may be connected to a core or another router. The “data” depicted may be packets including next spike times (i.e., next spike time packets) sent by a router or a core. In various embodiments, these packets may be denoted with an opcode (or a flag) in the packet header distinguishing them from other types of packets communicated over the NoC. Instead of forwarding these packets directly, the packet's next spike time data field may be compared with the current local next spike time using a comparator 706. The asynchronous merge block 704 may control which local next spike time is provided to the comparator 706 (and may provide arbitration, when multiple packets including next spike times are ready to be processed). The comparator 706 may compare the selected local next spike time with a current local next spike time stored in buffer 708. If the selected local next spike time is lower than the local next spike time stored in buffer 708, the selected local next spike time is stored as the current local next spike time in buffer 708. The asynchronous merge block 704 may also send a request signal to counter 710, which tracks the number of local next spike times that have been processed. The request signal may increment the value stored by counter 710. The value stored by the counter may be compared against a Number of Inputs value 712 which may be configured before operation of the neural network. The Number of Inputs may be equal to the number of local next spike times the router is expected to receive after a time-step is processed and the local next spike times are sent to the central entity. Once the value of counter 710 is equal to the number of inputs, all of the local next spike times have been processed and the value stored by the minimum buffer 708 represents the local next spike time for the router. The router may generate a packet containing the local next spike time and send the packet in a pre-programmed direction toward the central location (e.g., the spanning tree's root node). For example, the packet may be sent through an output port to the next hop router. If the router is the central router, the local next spike time that it calculated is the global next spike time and may be communicated via multiple different output ports as a multicast packet.

After the local next spike time is communicated to the output port, the minimum buffer 708 and counter 710 are reset. In one embodiment, the minimum buffer 708 may be set to value high enough to ensure that any local next spike time received will be less than the reset value and will overwrite the reset value.

Although the logic depicted is asynchronous (e.g., configured for use in an asynchronous NoC), any suitable circuit techniques may be used (e.g., the logic may include synchronous circuits adapted for a synchronous NoC). In particular embodiments, the logic may utilize a blocking 1-flit per packet flow control (e.g., for the request and ack signals), though any suitable flow control with guaranteed delivery may be used in various embodiments. In the embodiment depicted, the request and ack signals may be utilized to provide flow control. For example, once an input (e.g., data) signal is valid and a target of the data is ready (as indicated by an ack signal sent by the target), a request signal may be asserted or toggled at which point the data will be received by the target (e.g., an input port may latch data received at its input when the request signal is asserted and the input port is available to accept new data). If a downstream circuit isn't ready, the state of the ack signal may instruct the input port not to accept data. In the embodiment depicted, the ack signal sent by the output port may reset the counter 710 to zero and set the min buffer 708 to the max value after the next spike time has been sent.

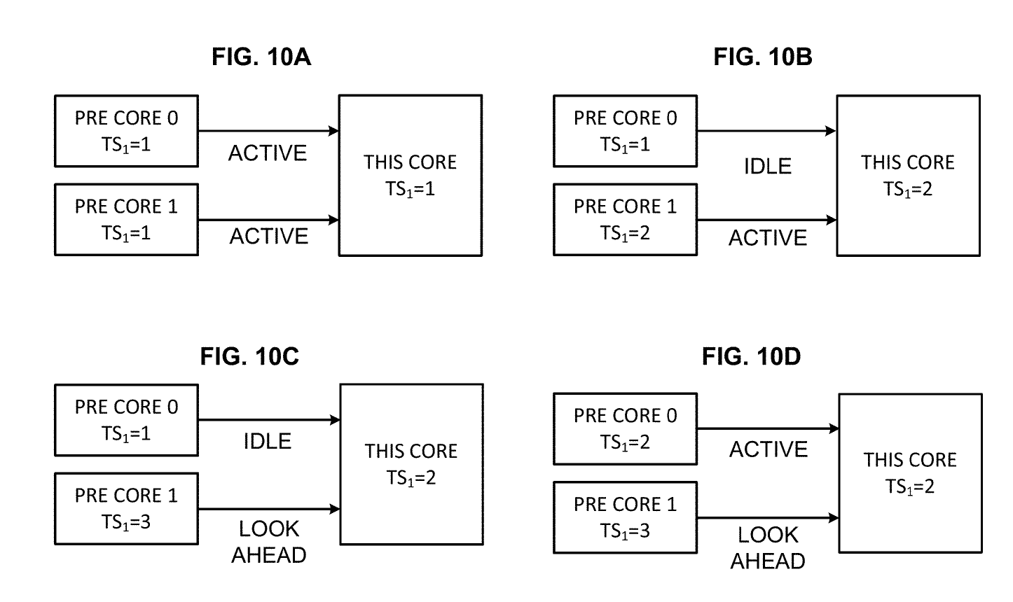

FIG. 8 illustrates an example flow 800 for calculating a next spike time and receiving a global spike time in accordance with certain embodiments. The flow may be performed, e.g., by a network element 102 (e.g., a router and/or one or more neuromorphic cores).

At 802, a first time-step is processed. For example, one or more neuromorphic cores may update membrane potentials of their neural units. At 804, the one or more neuromorphic cores may determine the next time-step that any of the neural units will spike in the absence of input spikes. These next spike times may be provided to a router connected to the neuromorphic core(s).

At 806, one or more next spike times are received from one or more adjacent nodes (e.g., routers). At 808, a minimum next spike time is selected from the next spike times received from the router(s) and/or core(s). At 810, the selected minimum next spike time is forwarded to an adjacent node (e.g., the next hop router of a spanning tree having its root node at a central entity).

At a later time, the router may receive the next time-step (i.e., the global next spike time) from an adjacent node at 812. At 814, the router may forward the next time-step to one or more adjacent nodes (e.g., the neuromorphic cores and/or routers from which it received next spike times at 806).

Some of the blocks illustrated in FIG. 8 may be repeated, combined, modified or deleted where appropriate, and additional blocks may also be added to the flowchart. Additionally, blocks may be performed in any suitable order without departing from the scope of particular embodiments.

Although the embodiments above focus on communicating the global time step to all cores, in some embodiments, spike dependencies may only need only be resolved between interconnected neural units, for example neighboring layers of neural units in a neural network. Accordingly, the global next spike time may be communicated to any suitable group of cores that are to process the spikes (or that otherwise have a need to receive the spike time). Thus, for example, in a particular neural network, cores may be divided into separate domains and a global time step is calculated for each domain at a central location of the respective domain (in a manner similar to that described above), e.g., in accordance with a spanning tree for the respective domain, and communicated only to the cores of that respective domain.

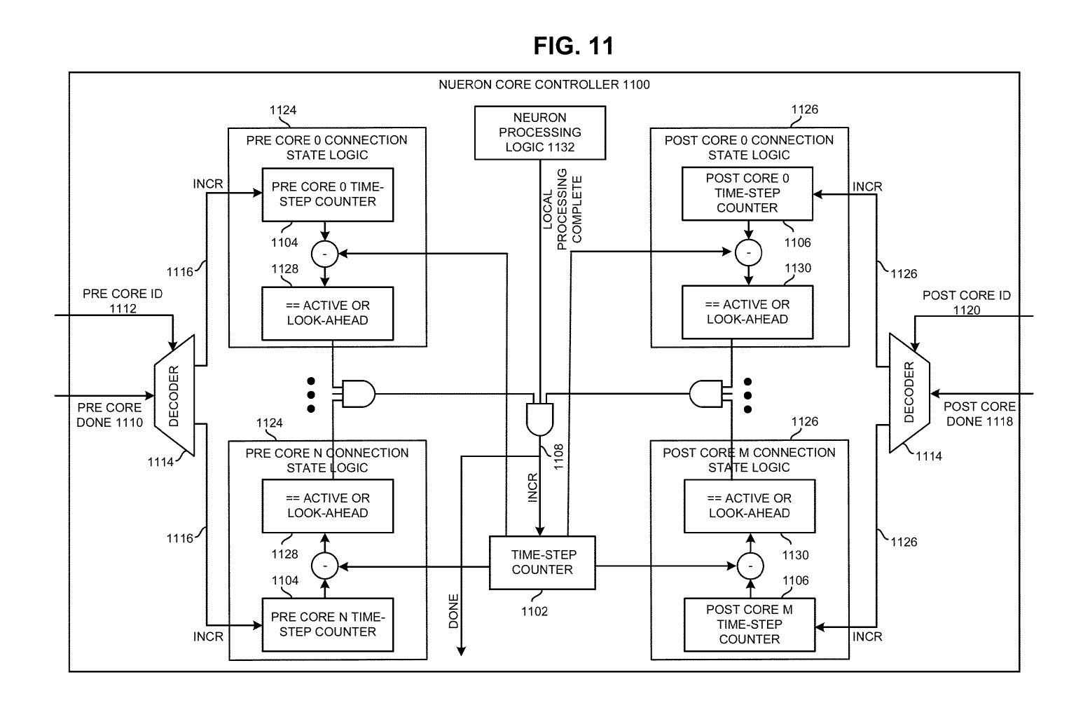

FIG. 9 illustrates allowable relative time-steps between two connected neuron cores for a localized time-step determination scheme in accordance with certain embodiments. Neuromorphic processors may run SNNs with extremely parallel spike processing within a time-step and spike dependencies necessitating in-order processing between time-steps. Within a single time-step, all spikes are independent. However, because the behavior of spikes in one time-step determines which neural units will spike in subsequent time-steps, spike dependencies between time-steps exist.

Coordinating time-steps to resolve spike dependencies in multi-core neuromorphic processors to resolve spike dependencies is a latency-critical operation. The duration of a time-step is not easily predictable, since spiking neural networks have variable amounts of computation per time-step per core. Some systems may resolve spike dependencies in a global manner, by keeping all cores in the SNN at the same time-step. Some systems may allocate the maximum possible number of hardware clock cycles to compute each time-step. In such systems, even if every neuron in the SNN spikes simultaneously, the neuromorphic processor will be able to complete all of the computations before the end of the time-step. The time-step duration may be fixed (and may not be dependent on workload). Since spike rates for SNNs are typically low (spike rates may even dip below 1%), this technique may result in many wasted clock cycles and unnecessary latency penalties. Other systems (e.g., embodiments described in connection with FIGS. 5-8) may detect the end of a time-step when every core has finished its local processing for a time-step. Such systems benefit from a shorter average time-step duration (the time-step duration is set by the execution time of the slowest core at each time-step) but utilize a global collective operation and a global time-step is shared among the cores.

Various embodiments of the present disclosure control the time-steps of the neuromorphic cores on a core by core basis using local communications between cores connected in the SNN while preserving proper processing of spike dependencies. Since spike dependencies only exist between connected neural units, tracking the time-steps for each core's connected neurons may enable spike dependencies to be addressed without strict global synchronization. Thus, each neuromorphic core may keep track of the time-step that neighboring cores (i.e., cores that provide inputs to or receive outputs from the particular core) are in, and increment its own time-step when spikes from input cores (i.e., cores having fan-in neural units for neural units of the core) have been received, local spike processing is completed, and any output cores (i.e., cores having fan-out neural units for neural units of the core) are ready to receive new spikes. Cores closer to the input of the SNN (upstream cores) are allowed to compute neural unit processing for time-steps ahead of downstream cores and to cache future spikes and partial integration results for later use. Thus, various embodiments may achieve time-step control for an entire multi-core neuromorphic processor in a distributed manner utilizing local communication.

Particular embodiments may increase hardware scalability to support larger SNNs, such as brain-scale networks. Various embodiments of the present disclosure decrease the latency of performing SNN workloads on neuromorphic processors. For example, particular embodiments may improve latency by roughly 24% in a 16-core fully recurrent SNN Latency and roughly 20% for a 16-core feed-forward SNN when each core is allowed to process one time-step into the future. Latency may be further improved by increasing the number of time-steps into the future the cores are allowed to process.

FIG. 9A illustrates relative time-steps allowed between two connected neuron cores (a “PRE core” and “THIS core”). The PRE core may be a core that includes neural units that are fan-in neural units to one or more neural units of THIS core (thus when a neural unit of the PRE core spikes, the spike may be sent to one or more neural units of THIS core). THIS core may be connected to any suitable number of PRE cores. The states depicted assume that THIS core is at time-step t. Spikes received at THIS core from the PRE core for time-step t−1 are processed in THIS core at time-step t. If the PRE core and THIS core are in the same time-step t, then THIS core may process completed PRE spikes from time-step t−1, and the connection is active. If THIS core is ahead of the PRE core (e.g., at time-step t−1), then the PRE spikes are not completed and THIS connection is Idle as THIS core waits for the PRE core to catch up. If the PRE core is ahead of THIS core (e.g., at time-step t+1, t+2, . . . t+n), then THIS core may be busy computing a previous time-step or may be waiting for inputs from a different connection. While THIS core is waiting for inputs from other PRE cores, THIS core may process spikes for future time-steps from PRE cores with which it has a look ahead connection. The processing results are stored in separate buffers (e.g., a separate buffer for each time-step) to ensure in-order operation. The number of buffer resources available may determine how many time-steps a core may process ahead of its PRE cores (e.g., the number of Look Ahead states may vary from 1 to n, where n is the number of buffers available to store spikes from PRE cores). When this limit is reached with respect to a particular PRE core, the PRE core may be prevented from further incrementing its time-step, which is depicted by the pre idle connection.

FIG. 9B illustrates relative time-steps allowed between two connected neuron cores (THIS core and a “POST core”). The POST core may be a core that includes neural units that are fan-out neural units to one or more neural units of THIS core (thus when a neural unit of THIS core spikes, the spike may be sent to one or more neural units of the POST core). THIS core may be connected to any suitable number of POST cores. The states depicted assume that THIS core is at time-step t. These connection states mirror the connection states between the PRE core and THIS core. For example, when the POST core is too far behind THIS core at t−n−1, the connection between THIS core and the POST core is idle (as there are not enough buffer resources in the POST core to store additional spikes from THIS core). When the POST core is at time-steps t−n through t−1, the connection state is a Look Ahead state as the POST core may buffer and process input. When the POST core is ahead of THIS core at time-step t+1, the connection is post idle as spikes for time t are not yet available for the POST core to process at time-step t+1.

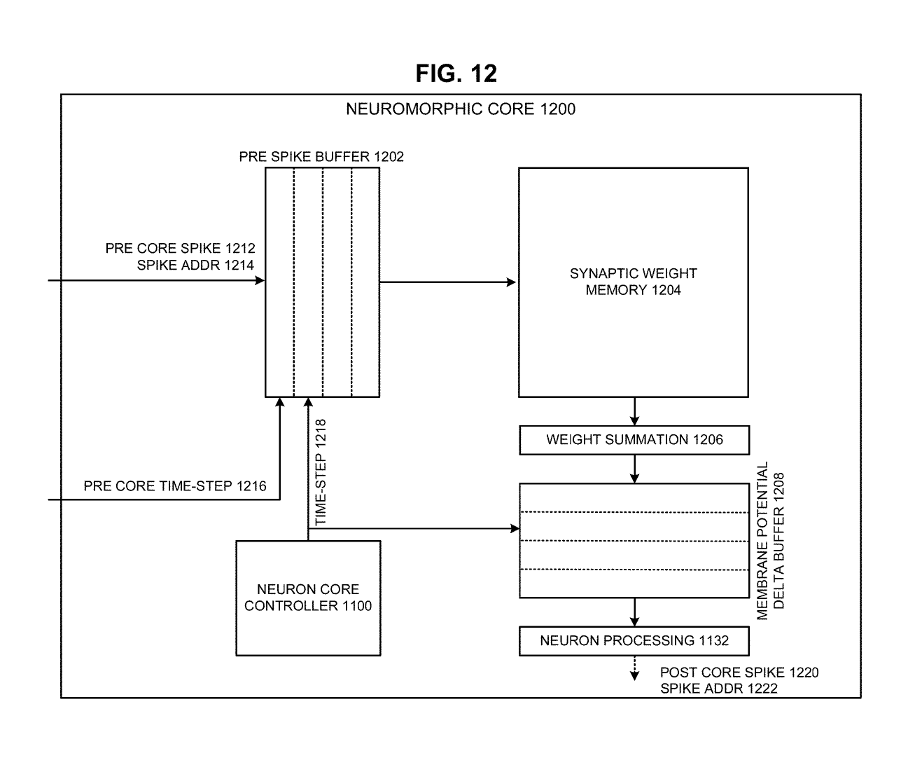

FIGS. 10A-10D illustrate a sequence of connection states between multiple cores in accordance with certain embodiments. This sequence illustrates how local time-step synchronization allows look ahead computation (i.e., allows THIS core to process input spikes for some PRE cores for time-steps that are ahead of the latest time-step completed by THIS core) while maintaining in-order spike execution. In these Figures, THIS core is coupled to input cores PRE core 0 and PRE core 1. PRE core 0 and PRE core 1 both include neural units that provide spikes to one or more neural units of THIS core.

In FIG. 10A, all cores are in time-step 1, and THIS core may process spikes received from both PRE cores from time-step 0, thus both connection states are active. In FIG. 10B, PRE core 1 and THIS core have completed time-step 1, but PRE core 0 has not completed time-step 1. THIS core may process spikes from PRE core 1 from time-step 1, but must wait for input spikes from PRE core 0 for time-step 1 before completing time-step 2, thus the connection state with PRE core 0 is idle. In FIG. 10C, THIS core finishes processing spikes for time-step 1 from PRE core 1, but cannot complete time-step 1 because it is still waiting for spikes from PRE core 0 for time-step 1. THIS core may now perform look ahead processing by receiving spikes from Pre core 1 for time-step 2, storing the spikes in a buffer, and performing partial updates to the membrane potentials of neural units (the updates are not considered complete until all spikes have been received from all PRE cores for the particular time-step). In FIG. 10D, PRE core 0 finally completes time-step 1 and enters time-step 2 and spikes from PRE core 0 for time-step 1 arrive and are processed, thus the connection state between THIS core and PRE core 0 becomes active again. THIS core may then move to time-step 3.

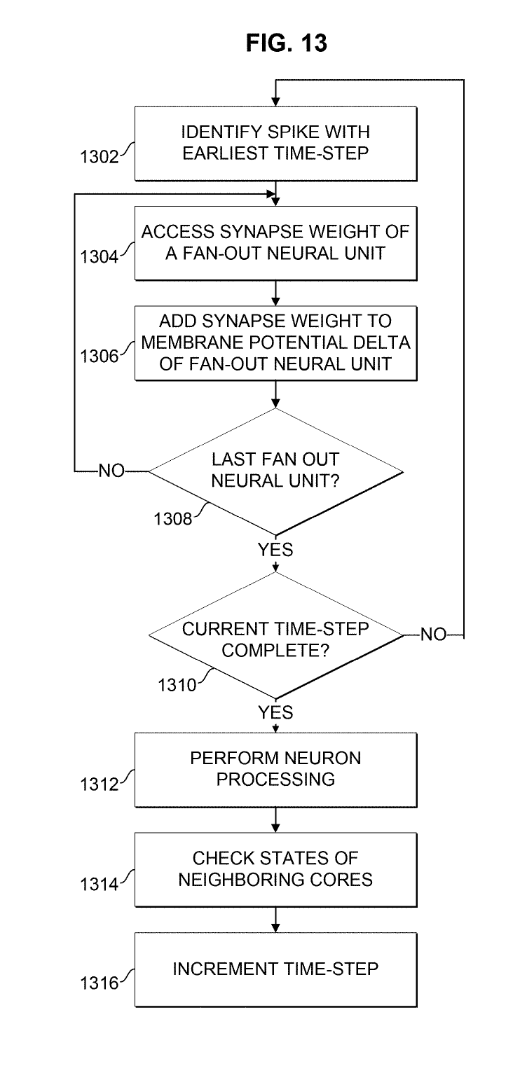

FIG. 11 illustrates an example neuron core controller 1100 for tracking time-steps of neuromorphic cores in accordance with certain embodiments. In a particular embodiment, the controller 1100 includes circuitry or other logic to perform the specified functions. Following the convention of FIGS. 9 and 10, the core that contains (or is otherwise associated with) the controller 1100 will be referred to as THIS core.

The neuron core controller 1100 may track the time-step of THIS core with time-step counter 1102. The neuron core controller may also track the time-steps of PRE cores with time-step counters 1104 and the time-steps of POST cores with time-step counters 1106. Counter 1102 may be incremented when THIS core has completed neuron processing (e.g., of all spikes for the current time-step) and connections with all neighboring cores (both PRE and POST cores) are in either the Active or Look-Ahead states. If a connection with any PRE core is in the Post Idle state then one or more additional input spikes may still be received from that PRE core for the current time-step of THIS core, thus the current time-step may not be incremented. If THIS core is at a time-step that is too far ahead of a POST core, then the connection may enter a Pre Idle state as the POST core (or other memory space accessible to the POST core) may run out of room to store output spikes of THIS core at the latest time-step. Once a time-step has been fully processed by THIS core and the connection states with THIS core's neighbor cores allow the core to move to the next time-step, a done signal 1108 increments the counter 1102.

When the time-step of THIS core is incremented, the done signal may also be sent (e.g., via a multi-cast message) to all PRE cores and POST cores connected to THIS core. THIS core may receive similar done signals from its PRE and POST cores when these cores increment their time-steps. THIS core keeps track of the time-step of its PRE and POST cores by incrementing the appropriate counter 1104 or 1106 when a done signal is received from a PRE or POST core. For example, in the embodiment depicted, THIS core may receive a PRE core done signal 1110 along with a PRE core ID that indicates the particular PRE core associated with the done signal (in a particular embodiment, a packet with the PRE core ID and the PRE core done signal may be sent from the PRE core to THIS core). Decoder 1114 may send an increment signal to the appropriate counter 1104 based on the PRE core ID. In this manner, THIS core may track the time-steps of each of its PRE cores. THIS core may also track the time-steps of each of its POST cores in a similar manner, utilizing POST core done signals 1118, POST core IDs 1120, and increment signals 1122. In other embodiments, any suitable signaling mechanisms for communicating done signals between cores and incrementing time-step counters may be used.

In order to determine which state the connections are in, the value of time-step counter 1102 may be provided to each PRE core connection state logic block 1124 and POST core connection state logic block 1126. The difference between the value of counter 1102 and the value of the respective counter 1104 or 1106 may be calculated and a corresponding connection state is identified based on the result. Each connection state logic block 1124 or 1126 may also include state output logic 1128 or 1130 which may output a signal that is asserted when the corresponding connection state is in an active or look-ahead state. The outputs of all of the state outputs may be combined and used (in combination with an output of neuron processing logic 1132 which indicates whether the spike buffer corresponding to the current time-step has any spikes remaining to be processed) to determine whether THIS core may increment its time-step.

In a particular embodiment, time-step counter 1102 may maintain a counter value that has more bits than the counter values maintained by time-step counters 1104 and 1106 (which in some embodiments may each hold the same number of bits). In one example, counter 1102 may be used for other operations of the neural network, while the time-step counters 1104 and 1106 are only used to track the state of the connections of THIS core. In embodiments wherein the time-step counter 1102 maintains more bits than the counter 1104 and 1106, a group of least significant bits (LSBs) of the counter 1102 is supplied to each connection state logic block 1124 and 1126 instead of the entire counter value. For example, a number of bits of the counter 1102 that matches the number of bits stored by counters 1104 and 1106 may be provided to blocks 1124 and 1126. The number of bits maintained by the counters 1104 and 1106 may be enough to represent the number of states, e.g., an active state, all look-ahead states, and at least one idle state (in a particular embodiment, the two different idle states may alias as they produce the same behavior). For example, two bit counters may be used to support two look ahead states, an active state, and an idle state or three bit counters may be used to support additional look ahead states.

In particular embodiments, instead of sending done signals to the PRE and POST cores when THIS core increments its time-step, an event-based approach may be taken wherein THIS core sends its updated time-step (or the LSBs of its updated time-step) to the PRE and POST cores. Accordingly, the counters 1104 and 1106 may be omitted in such embodiments and replaced with memories to store the received time-steps or other circuitry to facilitate the operation of core state logic 1128 and 1130.

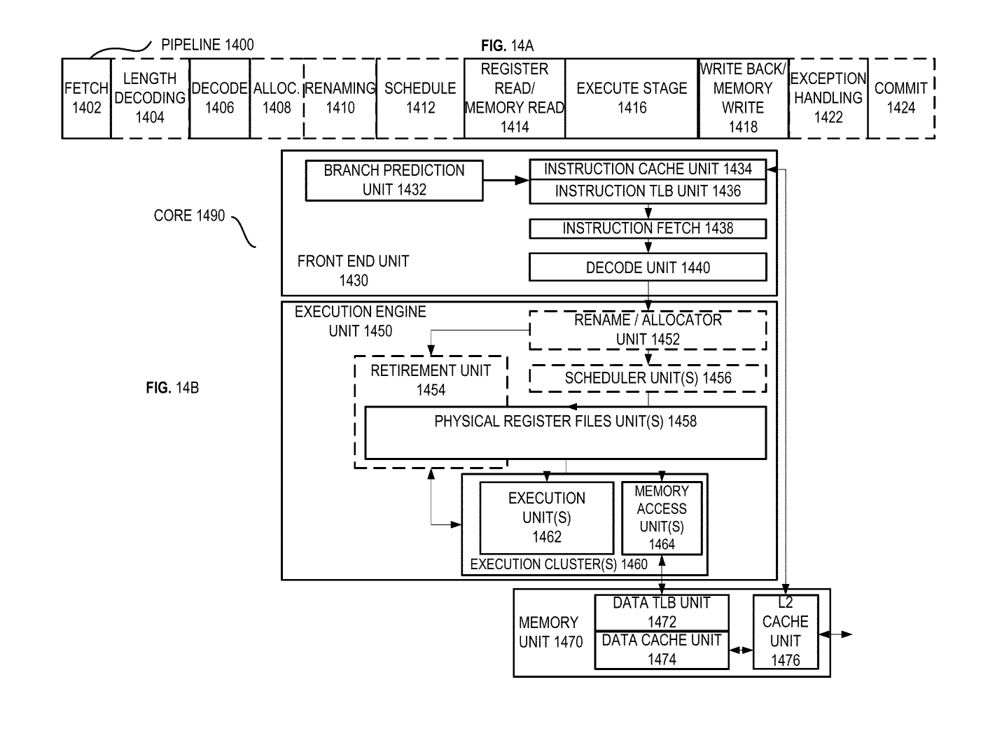

FIG. 12 illustrates a neuromorphic core 1200 in accordance with certain embodiments. The core 1200 may have any one or more characteristics of the other neuromorphic cores described herein. Core 1200 includes neuron core controller 1100, PRE spike buffer 1202, synaptic weight memory 1204, weight summation logic 1206, membrane potential delta buffer 1208, and neuron processing logic 1132.

PRE spike buffer 1202 stores input spikes (i.e., PRE core spikes 1212) to be processed for look ahead time-steps (these spikes may be output by one or more PRE cores at the current time-step or a future time-step) as well as input spikes to be processed for the current/active time-step of the core 1200 (these spikes may be output by one or more PRE cores at the previous time-step). In the embodiment depicted, PRE spike buffer 1202 includes four entries, with one entry being dedicated to spikes received from PRE cores for the current time-step, and three entries each dedicated to spikes received from the PRE cores for a particular look ahead time-step.

When a spike 1212 is received from a neural unit of a PRE core, it may be written to a location in PRE spike buffer 1202 based on an identifier (i.e., a PRE spike address 1214) of the neural unit that spiked and a specified time-step 1216 in which the neural unit spiked. Although the buffer 1202 may be addressed in any suitable manner, in a particular embodiment, the time-step 1216 may identify the column of the buffer 1202 and the PRE spike address 1214 may identify a row of the buffer 1202 (thus each row of buffer 1202 may correspond to a different neural unit of a PRE core). In some embodiments, each column of the buffer 1202 may be used to store spikes of a particular time-step.

In various embodiments, each spike may be sent in its own message (e.g., packet) from a PRE core to the core 1200. In other embodiments, spikes 1212 (and PRE spike addresses 1214) may be aggregated into a message and sent as a vector to the core 1200.

In addition to tracking states of neighboring cores (e.g., as described above), neuron core controller 1100 may coordinate the processing of spikes of various time-steps. In processing the spikes, the neuron core controller 1100 may prioritize spikes of the earliest time-step. Thus, the controller 1100 may process any spikes of the current time-step present in buffer 1202 before processing spikes of look ahead time-steps present in buffer 1202. The controller 1100 may also process any spikes of the first look ahead time-step present in buffer 1202 before processing spikes of the second look ahead time-step in buffer 1202, and so on.

In a particular embodiment, neuron core controller 1100 may read a spike from the buffer (e.g., by asserting the row and the column of the spike), and access synapse weights of connections between neural units of the core 1200 and the spiking neural unit. For example, if the neural unit that generated the spike is connected to each neural unit of core 1200, a row that includes synapse weights for every neural unit in the core 1200 may be accessed. Synaptic weight memory 1204 includes synapse weights for connections between fan-in neural units of the PRE cores and the neural units of the core 1200.

Weight summation logic 1206 may sum synapse weights for each neural unit of core 1200 separately into a membrane potential delta for that neuron. Thus, when a spike is sent to all of the neural units of the core 1200, weight summation logic 1206 may iterate through the neural units, adding the synapse weight for a spiking neural unit and the neural unit being updated to that neural unit's membrane potential delta for the applicable time-step.

The membrane potential delta buffer 1208 may include a plurality of entries that each correspond to a particular time-step. Within each entry, a set of membrane potential deltas are stored with each delta corresponding to a particular neural unit. The membrane potential deltas represent partial processing results for the neural units until the time-step is complete (i.e., all PRE cores have supplied their respective spikes). In a particular embodiment, the same column address (e.g., time-step 1218) used to access PRE spike buffer 1202 may also be used to access membrane potential delta buffer 1208 during the processing of a spike.

Once the time-step is complete, each neural unit is processed by neuron processing logic 1132 by adding its membrane potential delta for the current time-step to the neural unit's membrane potential at the end of the previous time-step (which may be stored by neuron processing logic 1132 or in a memory accessible to logic 1132). In some embodiments, if a particular neural unit is in a refractory period, the membrane potential delta is not added to the membrane potential for that neural unit. Neuron processing logic 1132 may perform any other suitable operations on the neural units, such as applying a bias and/or a leakage operation to the neural units as well as determining whether the neural unit is spiking at the current time-step. If a neural unit spikes, the neuron processing logic may send the spike 1220 to cores having fan-out neural units for the spiking neural unit (i.e., the POST cores) along with a spike address 1222 including an identifier of the neural unit that spiked.

In various embodiments, for a core with a large number of neural units, serial accesses to the synaptic weight memory 1204, and serial processing for weight summation and neuron processing may be performed, though any of these operations may be performed using any suitable methods.

In various embodiments, neuron core controller 1100 may facilitate the processing of an input spike 1212 by outputting a time-step 1218 that is used to access entries of the PRE spike buffer 1202 and the membrane potential delta buffer 1208. If all received input spikes of the current time-step have already been processed (and the core 1200 is waiting for one or more PRE cores to finish generating spikes that are to be processed for the current time-step), the neuron core controller 1100 may output an address corresponding to a look ahead time-step and process spikes from the look ahead time-step until additional input spikes are received for the current time-step (or the remaining PRE cores complete the time-step without sending additional spikes).

When a particular time-step has completed, the corresponding entry of PRE spike buffer 1202 and the entry of membrane potential delta buffer 1208 may be cleared (e.g., reset) and used for a future time-step.

In a particular embodiment, the number of PRE cores and POST cores for each neuromorphic core is predetermined when mapping the SNN to hardware and the logic of each core may be designed accordingly. For example, the neuron controller 1100 of each core may be adapted to the specific configuration of the core and may include, e.g., differing numbers of counters 1104 and 1106 based on the number of PRE cores and POST cores of the core. As another example, the number of rows of PRE spike buffer 1202 of core 1200 may be configured based on the number of neural units of the PRE cores for core 1200.

In the embodiments depicted, the number of allowable look ahead states is preconfigured before the neural network begins operation based on the number of entries in PRE spike buffer 1202 and membrane potential delta buffer 1208, though in other embodiments, the number of allowable look ahead states (i.e., the number of time-steps a core may proceed past a neighboring core) may be determined dynamically. For example, one or more local pools of memory could be shared among different time-steps and/or cores and portions of the memory could be dynamically allocated for use by the time-steps and/or cores (e.g. to store outputs and/or membrane potential deltas). In particular embodiments, a central controller could dynamically allocate the memory among the time-steps and/or cores in an intelligent manner to promote efficient operation of the neural network.

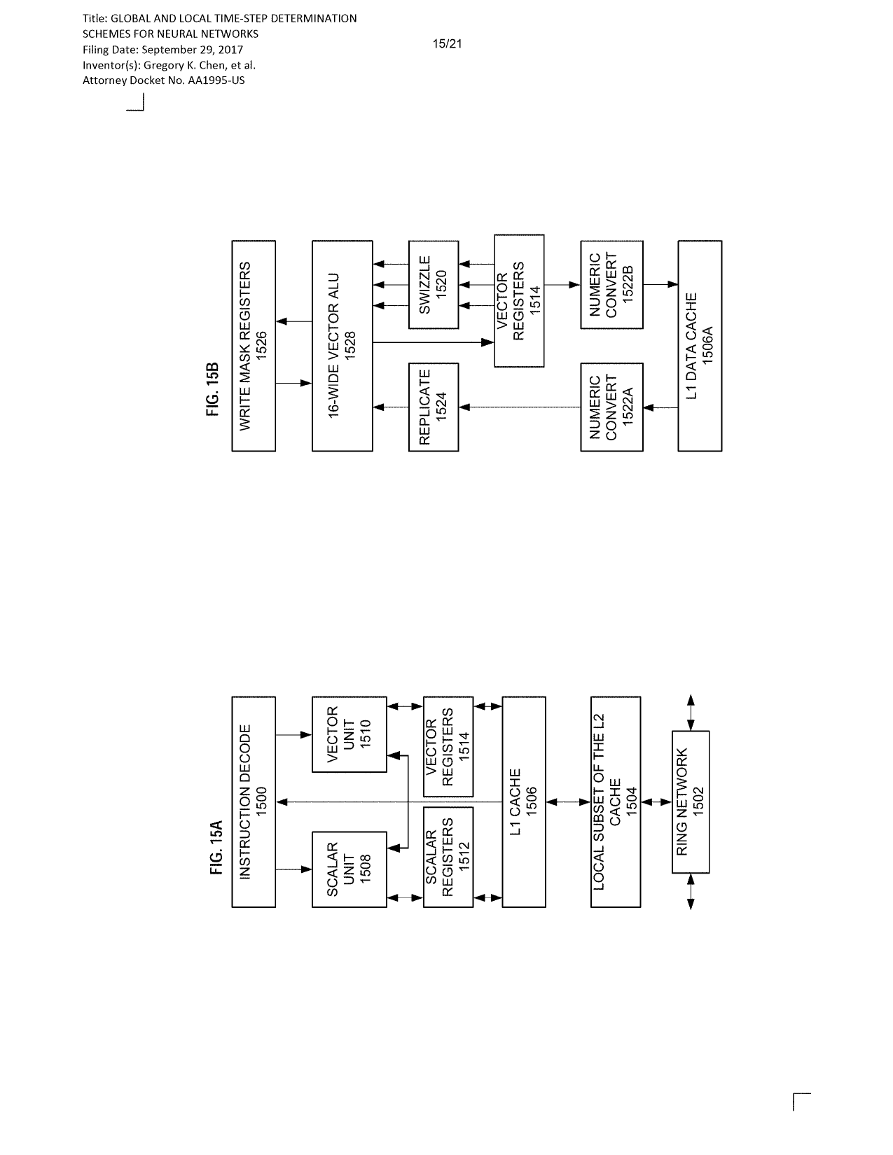

FIG. 13 illustrates a flow for processing spikes of various time-steps and incrementing a time-step of a neuromorphic core in accordance with certain embodiments. At 1302, a spike with an earliest time-step is identified. For example, spike buffer 1202 may be searched to determine whether any spikes are present in the buffer entry corresponding to the current time-step. If no spikes are present for the current time-step, the buffer entry corresponding to the next time-step may be searched and so on.

At 1304 a synapse weight of a fan-out neural unit for the spike is accessed. The synapse weight may be the weight of the connection between the spiking neural-unit and the neural unit to be updated (i.e., the fan-out neural unit). At 1306, the synapse weight is added to a membrane potential delta of the fan-out neural unit for the time-step associated with the spike (which may actually be one time-step later than the time-step in which the spike occurred).

At 1308, it is determined whether the neural unit that was just updated is the last fan-out neural unit of the neural unit that spiked. If it is not, the flow returns to 1304 and an additional neural unit is updated. If the neural unit is the last fan-out neural unit for the spike, then a determination is made at 1310 as to whether the current time-step is complete. For example, a time-step may be complete when all PRE cores have provided their input spikes to the core for that time-step and all of the spikes for that time-step have been processed. If the time-step is not complete, the flow may return to 1302 where additional spikes (either for the current time-step or for look-ahead time-steps) may be processed.

At 1312, after a determination that the current time-step is complete, neuron processing may be performed at 1312. For example, neuron processing logic 1132 may perform any suitable operations, such as determine which neural units spiked during the current timestep, apply leakage and/or bias terms, or perform other suitable operations. Output spikes may be propagated to the appropriate cores.

At 1314, the states of neighboring cores are checked. If the neighboring cores are all in states (e.g., time-steps) that result in connection states of active or look ahead with the core, the time-step of the core may be incremented at 1316. If any idle connections are present, the core may continue processing spikes for look-ahead time-steps until the connection states allow the time-step of the core to increment.

Some of the blocks illustrated in FIG. 13 may be repeated, combined, modified or deleted where appropriate, and additional blocks may also be added to the flowchart. Additionally, blocks may be performed in any suitable order without departing from the scope of particular embodiments.

The figures below detail exemplary architectures and systems to implement embodiments of the above. For example, the neuromorphic processor described above may be included within any of the systems described below. In some embodiments, the neuromorphic processor may be communicatively coupled to any of the processors below. In various embodiments, the neuromorphic processor may be implemented within and/or on the same chip as any of the processors described below. In some embodiments, one or more hardware components and/or instructions described above are emulated as detailed below, or implemented as software modules.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

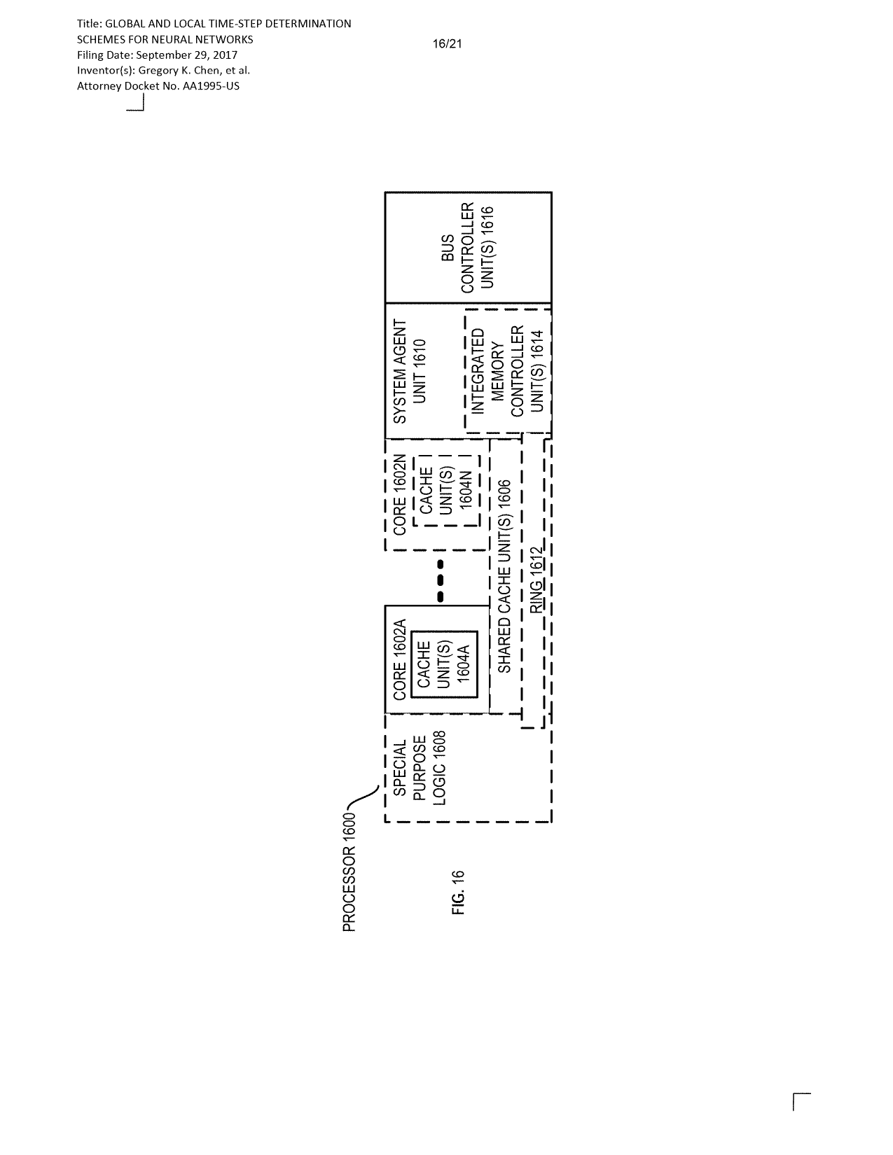

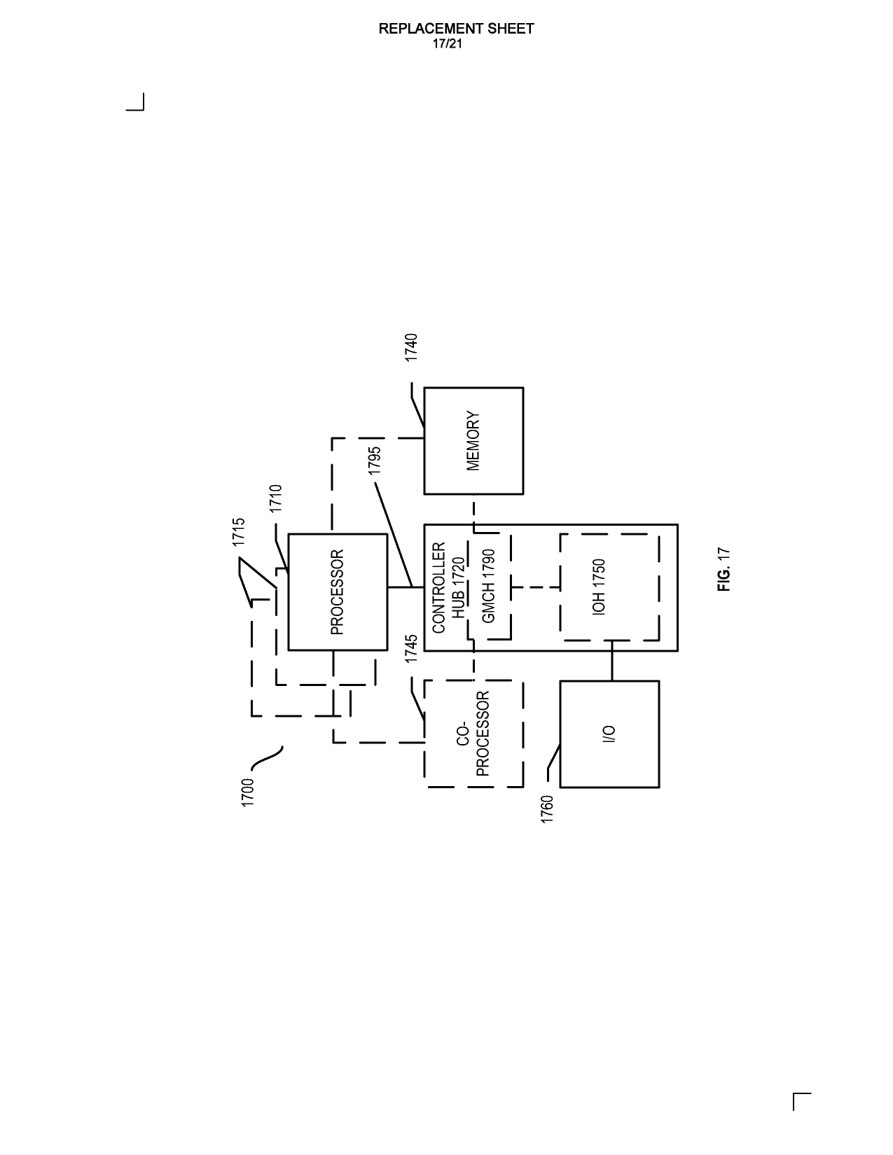

FIG. 14A is a block diagram illustrating both an exemplary in-order pipeline and an exemplary register renaming, out-of-order issue/execution pipeline according to embodiments of the disclosure. FIG. 14B is a block diagram illustrating both an exemplary embodiment of an in-order architecture core and an exemplary register renaming, out-of-order issue/execution architecture core to be included in a processor according to embodiments of the disclosure. The solid lined boxes in FIGS. 14A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 14A, a processor pipeline 1400 includes a fetch stage 1402, a length decode stage 1404, a decode stage 1406, an allocation stage 1408, a renaming stage 1410, a scheduling (also known as a dispatch or issue) stage 1412, a register read/memory read stage 1414, an execute stage 1416, a write back/memory write stage 1418, an exception handling stage 1422, and a commit stage 1424.

FIG. 14B shows processor core 1490 including a front end unit 1430 coupled to an execution engine unit 1450, and both are coupled to a memory unit 1470. The core 1490 may be a reduced instruction set computing (RISC) core, a complex instruction set computing (CISC) core, a very long instruction word (VLIW) core, or a hybrid or alternative core type. As yet another option, the core 1490 may be a special-purpose core, such as, for example, a network or communication core, compression and/or decompression engine, coprocessor core, general purpose computing graphics processing unit (GPGPU) core, graphics core, or the like.

The front end unit 1430 includes a branch prediction unit 1432 coupled to an instruction cache unit 1434, which is coupled to an instruction translation lookaside buffer (TLB) 1436, which is coupled to an instruction fetch unit 1438, which is coupled to a decode unit 1440. The decode unit 1440 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1440 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1490 includes a microcode ROM or other medium that stores microcode for certain macroinstructions (e.g., in decode unit 1440 or otherwise within the front end unit 1430). The decode unit 1440 is coupled to a rename/allocator unit 1452 in the execution engine unit 1450.

The execution engine unit 1450 includes the rename/allocator unit 1452 coupled to a retirement unit 1454 and a set of one or more scheduler unit(s) 1456. The scheduler unit(s) 1456 represents any number of different schedulers, including reservations stations, central instruction window, etc. The scheduler unit(s) 1456 is coupled to the physical register file(s) unit(s) 1458. Each of the physical register file(s) units 1458 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1458 comprises a vector registers unit, a write mask registers unit, and a scalar registers unit. These register units may provide architectural vector registers, vector mask registers, and general purpose registers. The physical register file(s) unit(s) 1458 is overlapped by the retirement unit 1454 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1454 and the physical register file(s) unit(s) 1458 are coupled to the execution cluster(s) 1460. The execution cluster(s) 1460 includes a set of one or more execution units 1462 and a set of one or more memory access units 1464. The execution units 1462 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1456, physical register file(s) unit(s) 1458, and execution cluster(s) 1460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1464). It should also be understood that where separate pipelines are used, one or more of these pipelines may be out-of-order issue/execution and the rest in-order.

The set of memory access units 1464 is coupled to the memory unit 1470, which includes a data TLB unit 1472 coupled to a data cache unit 1474 coupled to a level 2 (L2) cache unit 1476. In one exemplary embodiment, the memory access units 1464 may include a load unit, a store address unit, and a store data unit, each of which is coupled to the data TLB unit 1472 in the memory unit 1470. The instruction cache unit 1434 is further coupled to a level 2 (L2) cache unit 1476 in the memory unit 1470. The L2 cache unit 1476 is coupled to one or more other levels of cache and eventually to a main memory.

By way of example, the exemplary register renaming, out-of-order issue/execution core architecture may implement the pipeline 1400 as follows: 1) the instruction fetch 1438 performs the fetch and length decoding stages 1402 and 1404; 2) the decode unit 1440 performs the decode stage 1406; 3) the rename/allocator unit 1452 performs the allocation stage 1408 and renaming stage 1410; 4) the scheduler unit(s) 1456 performs the schedule stage 1412; 5) the physical register file(s) unit(s) 1458 and the memory unit 1470 perform the register read/memory read stage 1414; the execution cluster 1460 perform the execute stage 1416; 6) the memory unit 1470 and the physical register file(s) unit(s) 1458 perform the write back/memory write stage 1418; 7) various units may be involved in the exception handling stage 1422; and 8) the retirement unit 1454 and the physical register file(s) unit(s) 1458 perform the commit stage 1424.

The core 1490 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1490 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1434/1474 and a shared L2 cache unit 1476, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

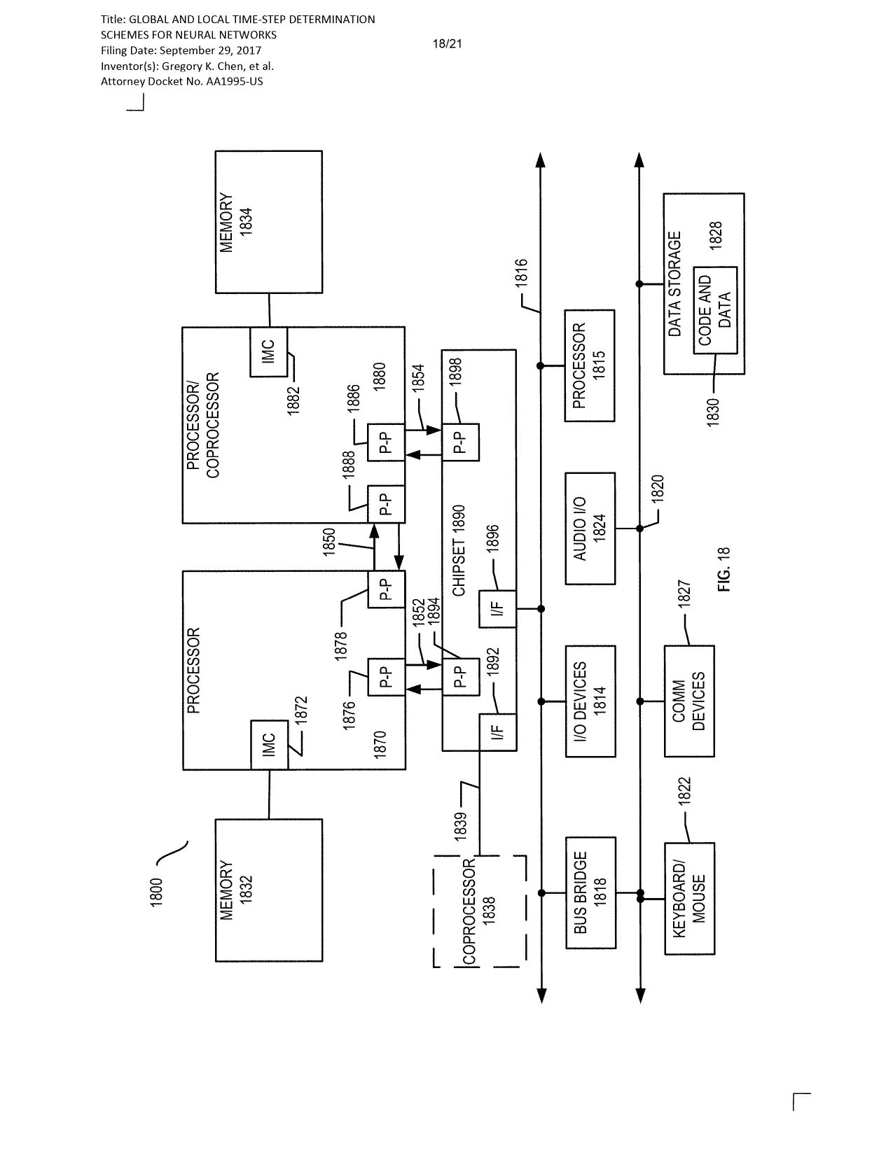

FIGS. 15A-B illustrate a block diagram of a more specific exemplary in-order core architecture, which core would be one of several logic blocks (potentially including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 15A is a block diagram of a single processor core, along with its connection to the on-die interconnect network 1502 and with its local subset of the Level 2 (L2) cache 1504, according to various embodiments. In one embodiment, an instruction decoder 1500 supports the x86 instruction set with a packed data instruction set extension. An L1 cache 1506 allows low-latency accesses to cache memory into the scalar and vector units. While in one embodiment (to simplify the design), a scalar unit 1508 and a vector unit 1510 use separate register sets (respectively, scalar registers 1512 and vector registers 1514) and data transferred between them is written to memory and then read back in from a level 1 (L1) cache 1506, alternative embodiments may use a different approach (e.g., use a single register set or include a communication path that allow data to be transferred between the two register files without being written and read back).

The local subset of the L2 cache 1504 is part of a global L2 cache that is divided into separate local subsets (in some embodiments one per processor core). Each processor core has a direct access path to its own local subset of the L2 cache 1504. Data read by a processor core is stored in its L2 cache subset 1504 and can be accessed quickly, in parallel with other processor cores accessing their own local L2 cache subsets. Data written by a processor core is stored in its own L2 cache subset 1504 and is flushed from other subsets, if necessary. The ring network ensures coherency for shared data. The ring network is bi-directional to allow agents such as processor cores, L2 caches and other logic blocks to communicate with each other within the chip. In a particular embodiment, each ring data-path is 1012-bits wide per direction.

FIG. 15B is an expanded view of part of the processor core in FIG. 15A according to embodiments. FIG. 15B includes an L1 data cache 1506A (part of the L1 cache 1506), as well as more detail regarding the vector unit 1510 and the vector registers 1514. Specifically, the vector unit 1510 is a 16-wide vector processing unit (VPU) (see the 16-wide ALU 1528), which executes one or more of integer, single-precision float, and double-precision float instructions. The VPU supports swizzling the register inputs with swizzle unit 1520, numeric conversion with numeric convert units 1522A-B, and replication with replication unit 1524 on the memory input. Write mask registers 1526 allow predicating resulting vector writes.

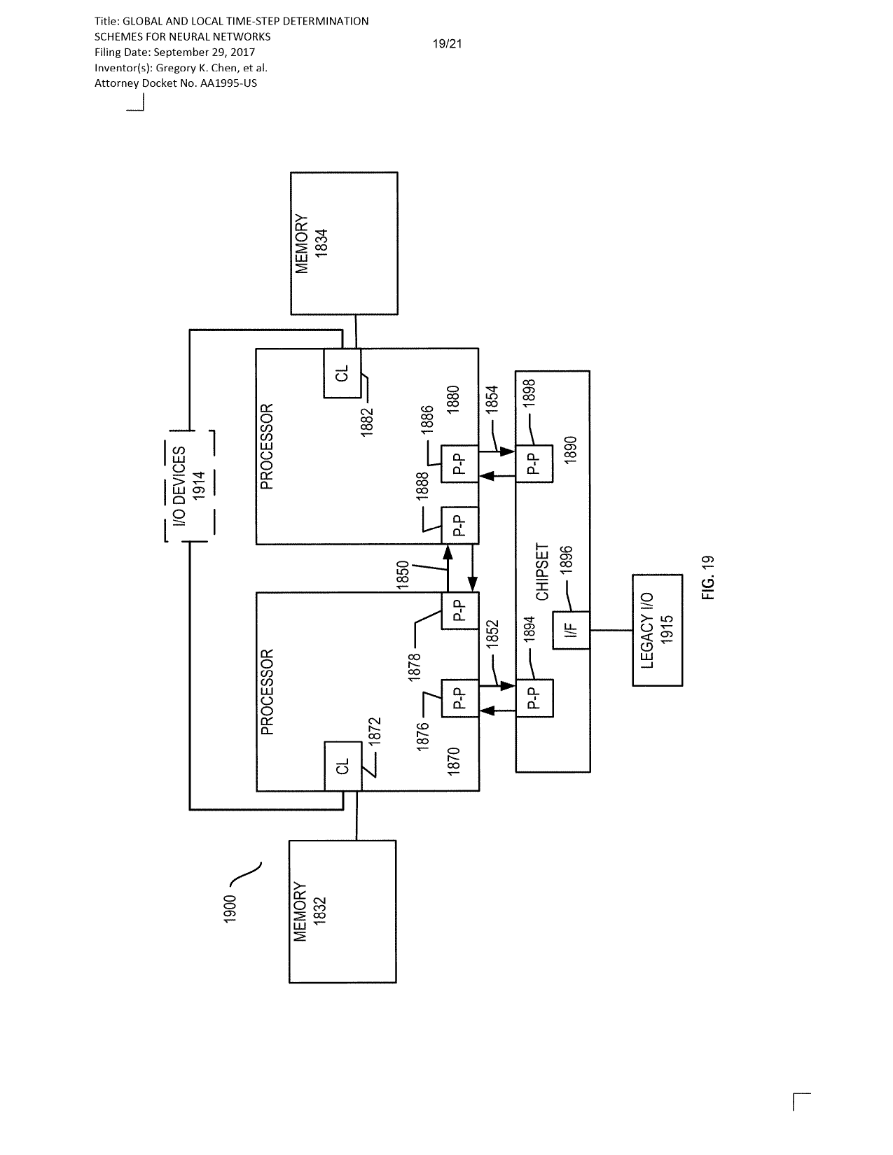

FIG. 16 is a block diagram of a processor 1600 that may have more than one core, may have an integrated memory controller, and may have integrated graphics according to various embodiments. The solid lined boxes in FIG. 16 illustrate a processor 1600 with a single core 1602A, a system agent 1610, and a set of one or more bus controller units 1616; while the optional addition of the dashed lined boxes illustrates an alternative processor 1600 with multiple cores 1602A-N, a set of one or more integrated memory controller unit(s) 1614 in the system agent unit 1610, and special purpose logic 1608.

Thus, different implementations of the processor 1600 may include: 1) a CPU with the special purpose logic 1608 being integrated graphics and/or scientific (throughput) logic (which may include one or more cores), and the cores 1602A-N being one or more general purpose cores (e.g., general purpose in-order cores, general purpose out-of-order cores, or a combination of the two); 2) a coprocessor with the cores 1602A-N being a large number of special purpose cores intended primarily for graphics and/or scientific (throughput); and 3) a coprocessor with the cores 1602A-N being a large number of general purpose in-order cores. Thus, the processor 1600 may be a general-purpose processor, coprocessor or special-purpose processor, such as, for example, a network or communication processor, compression and/or decompression engine, graphics processor, GPGPU (general purpose graphics processing unit), a high-throughput many integrated core (MIC) coprocessor (e.g., including 30 or more cores), embedded processor, or other fixed or configurable logic that performs logical operations. The processor may be implemented on one or more chips. The processor 1600 may be a part of and/or may be implemented on one or more substrates using any of a number of process technologies, such as, for example, BiCMOS, CMOS, or NMOS.

In various embodiments, a processor may include any number of processing elements that may be symmetric or asymmetric. In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

The memory hierarchy includes one or more levels of cache within the cores, a set or one or more shared cache units 1606, and external memory (not shown) coupled to the set of integrated memory controller units 1614. The set of shared cache units 1606 may include one or more mid-level caches, such as level 2 (L2), level 3 (L3), level 4 (L4), or other levels of cache, a last level cache (LLC), and/or combinations thereof. While in one embodiment a ring based interconnect unit 1612 interconnects the special purpose logic (e.g., integrated graphics logic) 1608, the set of shared cache units 1606, and the system agent unit 1610/integrated memory controller unit(s) 1614, alternative embodiments may use any number of well-known techniques for interconnecting such units. In one embodiment, coherency is maintained between one or more cache units 1606 and cores 1602A-N.

In some embodiments, one or more of the cores 1602A-N are capable of multithreading. The system agent 1610 includes those components coordinating and operating cores 1602A-N. The system agent unit 1610 may include for example a power control unit (PCU) and a display unit. The PCU may be or include logic and components needed for regulating the power state of the cores 1602A-N and the special purpose logic 1608. The display unit is for driving one or more externally connected displays.

The cores 1602A-N may be homogenous or heterogeneous in terms of architecture instruction set; that is, two or more of the cores 1602A-N may be capable of executing the same instruction set, while others may be capable of executing only a subset of that instruction set or a different instruction set.

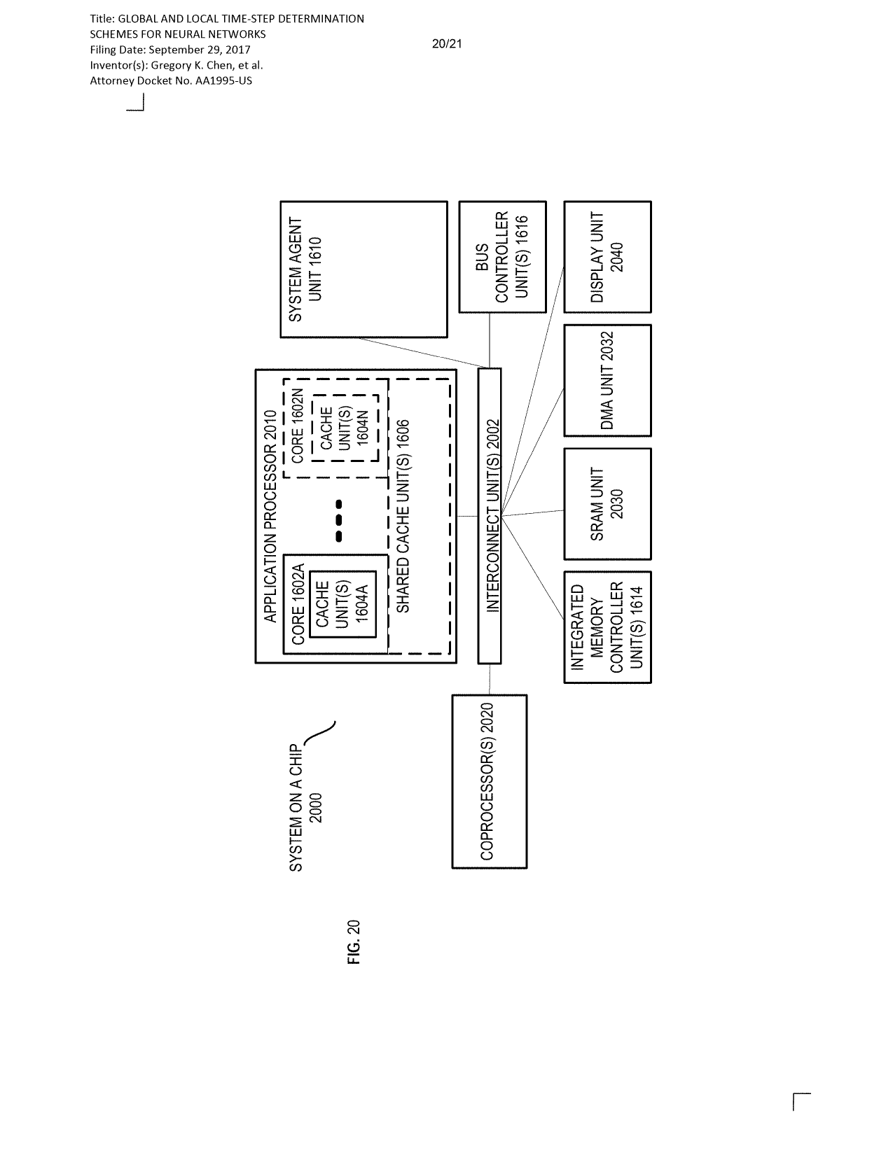

FIGS. 17-20 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable for performing the methods described in this disclosure. In general, a huge variety of systems or electronic devices capable of incorporating a processor and/or other execution logic as disclosed herein are generally suitable.

FIG. 17 depicts a block diagram of a system 1700 in accordance with one embodiment of the present disclosure. The system 1700 may include one or more processors 1710, 1715, which are coupled to a controller hub 1720. In one embodiment, the controller hub 1720 includes a graphics memory controller hub (GMCH) 1790 and an Input/Output Hub (IOH) 1750 (which may be on separate chips or the same chip); the GMCH 1790 includes memory and graphics controllers coupled to memory 1740 and a coprocessor 1745; the IOH 1750 couples input/output (I/O) devices 1760 to the GMCH 1790. Alternatively, one or both of the memory and graphics controllers are integrated within the processor (as described herein), the memory 1740 and the coprocessor 1745 are coupled directly to the processor 1710, and the controller hub 1720 is a single chip comprising the IOH 1750.

The optional nature of additional processors 1715 is denoted in FIG. 17 with broken lines. Each processor 1710, 1715 may include one or more of the processing cores described herein and may be some version of the processor 1600.

The memory 1740 may be, for example, dynamic random access memory (DRAM), phase change memory (PCM), other suitable memory, or any combination thereof. The memory 1740 may store any suitable data, such as data used by processors 1710, 1715 to provide the functionality of computer system 1700. For example, data associated with programs that are executed or files accessed by processors 1710, 1715 may be stored in memory 1740. In various embodiments, memory 1740 may store data and/or sequences of instructions that are used or executed by processors 1710, 1715.

In at least one embodiment, the controller hub 1720 communicates with the processor(s) 1710, 1715 via a multi-drop bus, such as a frontside bus (FSB), point-to-point interface such as QuickPath Interconnect (QPI), or similar connection 1795.

In one embodiment, the coprocessor 1745 is a special-purpose processor, such as, for example, a high-throughput MIC processor, a network or communication processor, compression and/or decompression engine, graphics processor, GPGPU, embedded processor, or the like. In one embodiment, controller hub 1720 may include an integrated graphics accelerator.

There can be a variety of differences between the physical resources 1710, 1715 in terms of a spectrum of metrics of merit including architectural, microarchitectural, thermal, power consumption characteristics, and the like.

In one embodiment, the processor 1710 executes instructions that control data processing operations of a general type. Embedded within the instructions may be coprocessor instructions. The processor 1710 recognizes these coprocessor instructions as being of a type that should be executed by the attached coprocessor 1745. Accordingly, the processor 1710 issues these coprocessor instructions (or control signals representing coprocessor instructions) on a coprocessor bus or other interconnect, to coprocessor 1745. Coprocessor(s) 1745 accept and execute the received coprocessor instructions.

FIG. 18 depicts a block diagram of a first more specific exemplary system 1800 in accordance with an embodiment of the present disclosure. As shown in FIG. 18, multiprocessor system 1800 is a point-to-point interconnect system, and includes a first processor 1870 and a second processor 1880 coupled via a point-to-point interconnect 1850. Each of processors 1870 and 1880 may be some version of the processor 1600. In one embodiment of the disclosure, processors 1870 and 1880 are respectively processors 1710 and 1715, while coprocessor 1838 is coprocessor 1745. In another embodiment, processors 1870 and 1880 are respectively processor 1710 and coprocessor 1745.

Processors 1870 and 1880 are shown including integrated memory controller (IMC) units 1872 and 1882, respectively. Processor 1870 also includes as part of its bus controller unit's point-to-point (P-P) interfaces 1876 and 1878; similarly, second processor 1880 includes P-P interfaces 1886 and 1888. Processors 1870, 1880 may exchange information via a point-to-point (P-P) interface 1850 using P-P interface circuits 1878, 1888. As shown in FIG. 18, IMCs 1872 and 1882 couple the processors to respective memories, namely a memory 1832 and a memory 1834, which may be portions of main memory locally attached to the respective processors.

Processors 1870, 1880 may each exchange information with a chipset 1890 via individual P-P interfaces 1852, 1854 using point to point interface circuits 1876, 1894, 1886, 1898. Chipset 1890 may optionally exchange information with the coprocessor 1838 via a high-performance interface 1839. In one embodiment, the coprocessor 1838 is a special-purpose processor, such as, for example, a high-throughput MIC processor, a network or communication processor, compression and/or decompression engine, graphics processor, GPGPU, embedded processor, or the like.

A shared cache (not shown) may be included in either processor or outside of both processors, yet connected with the processors via a P-P interconnect, such that either or both processors' local cache information may be stored in the shared cache if a processor is placed into a low power mode.

Chipset 1890 may be coupled to a first bus 1816 via an interface 1896. In one embodiment, first bus 1816 may be a Peripheral Component Interconnect (PCI) bus, or a bus such as a PCI Express bus or another third generation I/O interconnect bus, although the scope of the present disclosure is not so limited.

As shown in FIG. 18, various I/O devices 1814 may be coupled to first bus 1816, along with a bus bridge 1818 which couples first bus 1816 to a second bus 1820. In one embodiment, one or more additional processor(s) 1815, such as coprocessors, high-throughput MIC processors, GPGPU's, accelerators (such as, e.g., graphics accelerators or digital signal processing (DSP) units), field programmable gate arrays, or any other processor, are coupled to first bus 1816. In one embodiment, second bus 1820 may be a low pin count (LPC) bus. Various devices may be coupled to a second bus 1820 including, for example, a keyboard and/or mouse 1822, communication devices 1827 and a storage unit 1828 such as a disk drive or other mass storage device which may include instructions/code and data 1830, in one embodiment.

Further, an audio I/O 1824 may be coupled to the second bus 1820. Note that other architectures are contemplated by this disclosure. For example, instead of the point-to-point architecture of FIG. 18, a system may implement a multi-drop bus or other such architecture.

FIG. 19 depicts a block diagram of a second more specific exemplary system 1900 in accordance with an embodiment of the present disclosure. Similar elements in FIGS. 18 and 19 bear similar reference numerals, and certain aspects of FIG. 18 have been omitted from FIG. 19 in order to avoid obscuring other aspects of FIG. 19.

FIG. 19 illustrates that the processors 1870, 1880 may include integrated memory and I/O control logic (“CL”) 1872 and 1882, respectively. Thus, the CL 1872, 1882 include integrated memory controller units and include I/O control logic. FIG. 19 illustrates that not only are the memories 1832, 1834 coupled to the CL 1872, 1882, but also that I/O devices 1914 are also coupled to the control logic 1872, 1882. Legacy I/O devices 1915 are coupled to the chipset 1890.

FIG. 20 depicts a block diagram of a SoC 2000 in accordance with an embodiment of the present disclosure. Similar elements in FIG. 16 bear similar reference numerals. Also, dashed lined boxes are optional features on more advanced SoCs. In FIG. 20, an interconnect unit(s) 2002 is coupled to: an application processor 2010 which includes a set of one or more cores 1602A-N and shared cache unit(s) 1606; a system agent unit 1610; a bus controller unit(s) 1616; an integrated memory controller unit(s) 1614; a set or one or more coprocessors 2020 which may include integrated graphics logic, an image processor, an audio processor, and a video processor; an static random access memory (SRAM) unit 2030; a direct memory access (DMA) unit 2032; and a display unit 2040 for coupling to one or more external displays. In one embodiment, the coprocessor(s) 2020 include a special-purpose processor, such as, for example, a network or communication processor, compression and/or decompression engine, GPGPU, a high-throughput MIC processor, embedded processor, or the like.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

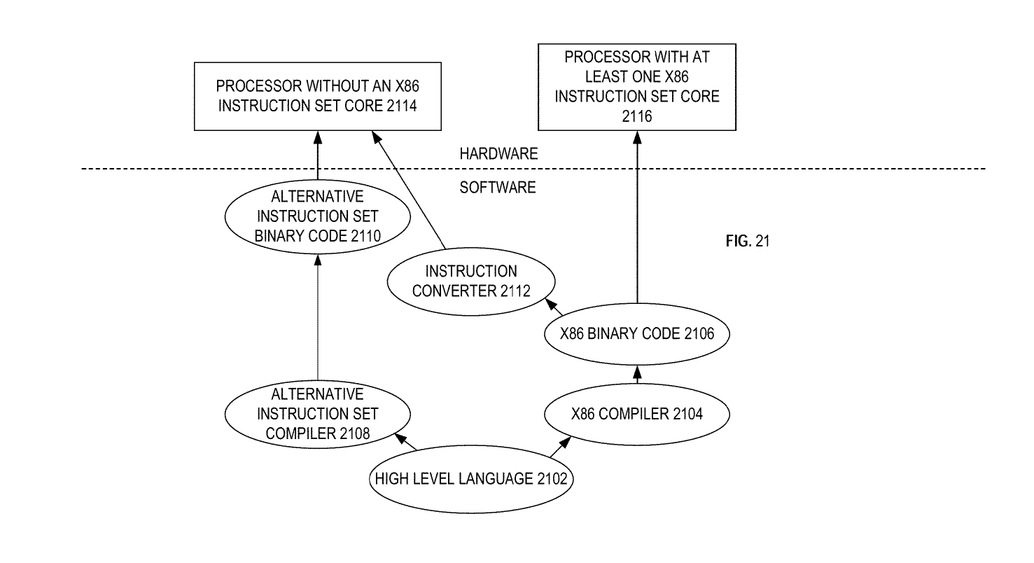

FIG. 21 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or various combinations thereof. FIG. 21 shows a program in a high level language 2102 may be compiled using an x86 compiler 2104 to generate x86 binary code 2106 that may be natively executed by a processor with at least one x86 instruction set core 2116. The processor with at least one x86 instruction set core 2116 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 2104 represents a compiler that is operable to generate x86 binary code 2106 (e.g., object code) that can, with or without additional linkage processing, be executed on the processor with at least one x86 instruction set core 2116. Similarly, FIG. 21 shows the program in the high level language 2102 may be compiled using an alternative instruction set compiler 2108 to generate alternative instruction set binary code 2110 that may be natively executed by a processor without at least one x86 instruction set core 2114 (e.g., a processor with cores that execute the MIPS instruction set of MIPS Technologies of Sunnyvale, Calif. and/or that execute the ARM instruction set of ARM Holdings of Sunnyvale, Calif.). The instruction converter 2112 is used to convert the x86 binary code 2106 into code that may be natively executed by the processor without an x86 instruction set core 2114. This converted code is not likely to be the same as the alternative instruction set binary code 2110 because an instruction converter capable of this is difficult to make; however, the converted code will accomplish the general operation and be made up of instructions from the alternative instruction set. Thus, the instruction converter 2112 represents software, firmware, hardware, or a combination thereof that, through emulation, simulation or any other process, allows a processor or other electronic device that does not have an x86 instruction set processor or core to execute the x86 binary code 2106.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the manufacture of the described hardware.

In any representation of the design, the data representing the design may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

Thus, one or more aspects of at least one embodiment may be implemented by representative instructions stored on a machine-readable medium which represents various logic within the processor, which when read by a machine causes the machine to fabricate logic to perform the techniques described herein. Such representations, often referred to as “IP cores” may be stored on a non-transitory tangible machine readable medium and supplied to various customers or manufacturing facilities to load into the fabrication machines that manufacture the logic or processor.

Embodiments of the mechanisms disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code, such as code 1830 illustrated in FIG. 18, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In various embodiments, the language may be a compiled or interpreted language.

The embodiments of methods, hardware, software, firmware or code set forth above may be implemented via instructions or code stored on a machine-accessible, machine readable, computer accessible, or computer readable medium which are executable (or otherwise accessible) by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information therefrom.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Logic may be used to implement any of the functionality of the various components such as network element 102, router 104, core 108, the logic of FIG. 7, neuron core controller 1100, neuromorphic core 1200, any processor described herein, other component described herein, or any subcomponent of any of these components. “Logic” may refer to hardware, firmware, software and/or combinations of each to perform one or more functions. As an example, logic may include hardware, such as a micro-controller or processor, associated with a non-transitory medium to store code adapted to be executed by the micro-controller or processor. Therefore, reference to logic, in one embodiment, refers to the hardware, which is specifically configured to recognize and/or execute the code to be held on a non-transitory medium. Furthermore, in another embodiment, use of logic refers to the non-transitory medium including the code, which is specifically adapted to be executed by the microcontroller to perform predetermined operations. And as can be inferred, in yet another embodiment, the term logic (in this example) may refer to the combination of the hardware and the non-transitory medium. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components, which may be implemented by, e.g., transistors. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. Often, logic boundaries that are illustrated as separate commonly vary and potentially overlap. For example, first and second logic may share hardware, software, firmware, or a combination thereof, while potentially retaining some independent hardware, software, or firmware.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1 's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

In at least one embodiment, a processor comprises a first neuromorphic core to implement a plurality of neural units of a neural network, the first neuromorphic core comprising a memory to store a current time-step of the first neuromorphic core; and a controller to track current time-steps of neighboring neuromorphic cores that receive spikes from or provide spikes to the first neuromorphic core; and control the current time-step of the first neuromorphic core based on the current time-steps of the neighboring neuromorphic cores.

In an embodiment, the first neuromorphic core is to process a spike received from a second neuromorphic core, wherein the spike occurs in a first time-step that is later than the current time-step of the first neuromorphic core when the spike is processed by the first neuromorphic core. In an embodiment, during a period of time in which the current time-step of the first neuromorphic core is a first time-step, the first neuromorphic core is to receive a first spike from a second neuromorphic core and a second spike from a third neuromorphic core, wherein the first spike occurs in a second time-step and the second output spike occurs in a time-step that is different from the second time-step. In an embodiment, during a period of time in which the current time-step of the first neuromorphic core is the first time-step, the first neuromorphic core is to process the first spike by accessing a first synapse weight associated with the first output spike and adjusting a first membrane potential delta; and process the second spike by accessing a second synapse weight associated with the second output spike and adjusting a second membrane potential delta. In an embodiment, the controller is to prevent the first neuromorphic core from advancing to a next time-step if a second neuromorphic core that is to send spikes to the first neuromorphic core is set to a time-step that is earlier than the current time-step of the first neuromorphic core. In an embodiment, the controller prevents the first neuromorphic core from advancing to a next time-step if a second neuromorphic core that is to receive spikes from the first neuromorphic core is set to a time-step that is earlier than the current time-step of the first neuromorphic core by more than a threshold number of time-steps. In an embodiment, the controller of the first neuromorphic core is to send a message to the neighboring neuromorphic cores indicating that the current time-step of the first neuromorphic core has been incremented when the current time-step of the first of the first neuromorphic core is incremented. In an embodiment, the controller of the first neuromorphic core is to send a message including at least a portion of the current time-step of the first neuromorphic core to the neighboring neuromorphic cores when the current time-step of the first of the first neuromorphic core changes by one or more timesteps. In an embodiment, the first neuromorphic core comprises a spike buffer, the spike buffer comprising a first entry to store spikes of a first time-step and a second entry to store spikes of a second time-step, wherein spikes of the first time-step and spikes of the second time-step are to be stored concurrently in the buffer. In an embodiment, the first neuromorphic core comprises a buffer comprising a first entry to store membrane potential delta values for the plurality of neural units for a first time-step and a second entry to store membrane potential delta values for the plurality of neural units for a second time-step. In an embodiment, the controller is to control the current time-step of the first neuromorphic core based on a number of allowed look ahead states, wherein the number of allowed look ahead states is determined by an amount of available memory to store spikes for the allowed look ahead states. In an embodiment, the processor further comprises a battery communicatively coupled to the processor, a display communicatively coupled to the processor, or a network interface communicatively coupled to the processor.

In at least one embodiment, a method comprises implementing a plurality of neural units of a neural network in a first neuromorphic core; storing a current time-step of the first neuromorphic core; tracking current time-steps of neighboring neuromorphic cores that receive spikes from or provide spikes to the first neuromorphic core; and controlling the current time-step of the first neuromorphic core based on the current time-steps of the neighboring neuromorphic cores.

In an embodiment, a method further comprises processing, at the first neuromorphic core, a spike received from a second neuromorphic core, wherein the spike occurs in a first time-step that is later than the current time-step of the first neuromorphic core when the spike is processed. In an embodiment, a method further comprises receiving at the first neuromorphic core, during a period of time in which the current time-step of the first neuromorphic core is a first time-step, a first spike from a second neuromorphic core and a second spike from a third neuromorphic core, wherein the first spike occurs in a second time-step and the second output spike occurs in a time-step that is different from the second time-step. In an embodiment, a method further comprises, during a period of time in which the first neuromorphic core is set to the first time-step, processing the first spike by accessing a first synapse weight associated with the first spike and adjusting a first membrane potential delta; and processing the second spike by accessing a second synapse weight associated with the second spike and adjusting a second membrane potential delta. In an embodiment, a method further comprises preventing the first neuromorphic core from advancing to a next time-step if a second neuromorphic core that is to send spikes to the first neuromorphic core is set to a time-step that is earlier than the current time-step of the first neuromorphic core. In an embodiment, a method further comprises preventing the first neuromorphic core from advancing to a next time-step if a second neuromorphic core that is to receive spikes from the first neuromorphic core is set to a time-step that is earlier than the current time-step of the first neuromorphic core by more than a threshold number of time-steps. In an embodiment, a method further comprises sending a message to the neighboring neuromorphic cores indicating that the current time-step of the first neuromorphic core has been incremented when the current time-step of the first of the first neuromorphic core is incremented. In an embodiment, a method further comprises sending a message including at least a portion of the current time-step of the first neuromorphic core to the neighboring neuromorphic cores when the current time-step of the first of the first neuromorphic core changes by one or more timesteps. In an embodiment, the first neuromorphic core comprises a spike buffer, the spike buffer comprising a first entry to store spikes of a first time-step and a second entry to store spikes of a second time-step, wherein spikes of the first time-step and spikes of the second time-step are to be stored concurrently in the buffer. In an embodiment, the first neuromorphic core comprises a buffer comprising a first entry to store membrane potential delta values for the plurality of neural units for a first time-step and a second entry to store membrane potential delta values for the plurality of neural units for a second time-step. In an embodiment, a method further comprises controlling the current time-step of the first neuromorphic core based on a number of allowed look ahead states, wherein the number of allowed look ahead states is determined by an amount of available memory to store spikes for the allowed look ahead states.

In at least one embodiment, a non-transitory machine readable storage medium has instructions stored thereon, the instructions when executed by a machine to cause the machine to implement a plurality of neural units of a neural network in a first neuromorphic core; store a current time-step of the first neuromorphic core; track current time-steps of neighboring neuromorphic cores that receive spikes from or provide spikes to the first neuromorphic core; and control the current time-step of the first neuromorphic core based on the current time-steps of the neighboring neuromorphic cores.

In an embodiment, the instructions when executed by the machine cause the machine to process, at the first neuromorphic core, a spike received from a second neuromorphic core, wherein the spike occurs in a first time-step that is later than the current time-step of the first neuromorphic core when the spike is processed. In an embodiment, the instructions when executed by the machine cause the machine to receive at the first neuromorphic core, during a period of time in which the current time-step of the first neuromorphic core is a first time-step, a first spike from a second neuromorphic core and a second spike from a third neuromorphic core, wherein the first spike occurs in a second time-step and the second output spike occurs in a time-step that is different from the second time-step. In an embodiment, the instructions when executed by the machine cause the machine to, during a period of time in which the current time-step of the first neuromorphic core is a first time-step, process the first spike by accessing a first synapse weight associated with the first spike and adjusting a first membrane potential delta; and process the second spike by accessing a second synapse weight associated with the second spike and adjusting a second membrane potential delta.

In at least one embodiment, a system comprises means for implementing a plurality of neural units of a neural network in a first neuromorphic core; means for storing a current time-step of the first neuromorphic core; means for tracking current time-steps of neighboring neuromorphic cores that receive spikes from or provide spikes to the first neuromorphic core; and means for controlling the current time-step of the first neuromorphic core based on the current time-steps of the neighboring neuromorphic cores.

In an embodiment, a system further comprises means for processing, at the first neuromorphic core, a spike received from a second neuromorphic core, wherein the spike occurs in a first time-step that is later than the current time-step of the first neuromorphic core when the spike is processed. In an embodiment, a system further comprising means for receiving at the first neuromorphic core, during a period of time in which the current time-step of the first neuromorphic core is a first time-step, a first spike from a second neuromorphic core and a second spike from a third neuromorphic core, wherein the first spike occurs in a second time-step and the second output spike occurs in a time-step that is different from the second time-step. In an embodiment, a system further comprising means for, during a period of time in which the first neuromorphic core is set to the first time-step, processing the first spike by accessing a first synapse weight associated with the first spike and adjusting a first membrane potential delta; and processing the second spike by accessing a second synapse weight associated with the second spike and adjusting a second membrane potential delta.

In at least one embodiment, a system comprises a processor comprising a first neuromorphic core to implement a plurality of neural units of the neural network, the first neuromorphic core comprising a memory to store a current time-step of the first neuromorphic core; and a controller to track current time-steps of neighboring neuromorphic cores that receive spikes from or provide spikes to the first neuromorphic core; and control the current time-step of the first neuromorphic core based on the current time-steps of the neighboring neuromorphic cores; the system further comprising a memory coupled to the processor to store results generated by the neural network.

In an embodiment, the system further comprises a network interface to transmit the results generated by the neural network. In an embodiment, the system further comprises a display to display the results generated by the neural network. In an embodiment, the system further comprises a cellular communication interface.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A processor comprising:
a first neuromorphic core to implement a plurality of neural units of a neural network, the first neuromorphic core comprising:
a memory to store a current time-step of the first neuromorphic core; and
a controller to:
track current time-steps of neighboring neuromorphic cores that receive spikes from or provide spikes to the first neuromorphic core; and
control the current time-step of the first neuromorphic core based on the current time-steps of the neighboring neuromorphic cores.

2. The processor of claim 1, wherein the first neuromorphic core is to process a spike received from a second neuromorphic core, wherein the spike occurs in a first time-step that is later than the current time-step of the first neuromorphic core when the spike is processed by the first neuromorphic core.

3. The processor of claim 1, wherein, during a period of time in which the current time-step of the first neuromorphic core is a first time-step, the first neuromorphic core is to receive a first spike from a second neuromorphic core and a second spike from a third neuromorphic core, wherein the first spike occurs in a second time-step and the second output spike occurs in a time-step that is different from the second time-step.

4. The processor of claim 3, wherein, during a period of time in which the current time-step of the first neuromorphic core is the first time-step, the first neuromorphic core is to:
process the first spike by accessing a first synapse weight associated with the first output spike and adjusting a first membrane potential delta; and
process the second spike by accessing a second synapse weight associated with the second output spike and adjusting a second membrane potential delta.

5. The processor of claim 1, wherein the controller is to prevent the first neuromorphic core from advancing to a next time-step if a second neuromorphic core that is to send spikes to the first neuromorphic core is set to a time-step that is earlier than the current time-step of the first neuromorphic core.

6. The processor of claim 1, wherein the controller prevents the first neuromorphic core from advancing to a next time-step if a second neuromorphic core that is to receive spikes from the first neuromorphic core is set to a time-step that is earlier than the current time-step of the first neuromorphic core by more than a threshold number of time-steps.

7. The processor of claim 1, wherein the controller of the first neuromorphic core is to send a message to the neighboring neuromorphic cores indicating that the current time-step of the first neuromorphic core has been incremented when the current time-step of the first of the first neuromorphic core is incremented.

8. The processor of claim 1, wherein the controller of the first neuromorphic core is to send a message including at least a portion of the current time-step of the first neuromorphic core to the neighboring neuromorphic cores when the current time-step of the first of the first neuromorphic core changes by one or more timesteps.

9. The processor of claim 1, wherein the first neuromorphic core comprises a spike buffer, the spike buffer comprising a first entry to store spikes of a first time-step and a second entry to store spikes of a second time-step, wherein spikes of the first time-step and spikes of the second time-step are to be stored concurrently in the buffer.

10. The processor of claim 1, wherein the first neuromorphic core comprises a buffer comprising a first entry to store membrane potential delta values for the plurality of neural units for a first time-step and a second entry to store membrane potential delta values for the plurality of neural units for a second time-step.

11. The processor of claim 1, wherein the controller is to control the current time-step of the first neuromorphic core based on a number of allowed look ahead states, wherein the number of allowed look ahead states is determined by an amount of available memory to store spikes for the allowed look ahead states.

12. The processor of claim 1, further comprising a battery communicatively coupled to the processor, a display communicatively coupled to the processor, or a network interface communicatively coupled to the processor.

13. A non-transitory machine readable storage medium having instructions stored thereon, the instructions when executed by a machine to cause the machine to:
implement a plurality of neural units of a neural network in a first neuromorphic core;
store a current time-step of the first neuromorphic core;
track current time-steps of neighboring neuromorphic cores that receive spikes from or provide spikes to the first neuromorphic core; and
control the current time-step of the first neuromorphic core based on the current time-steps of the neighboring neuromorphic cores.

14. The medium of claim 13, the instructions when executed by the machine to cause the machine to process, at the first neuromorphic core, a spike received from a second neuromorphic core, wherein the spike occurs in a first time-step that is later than the current time-step of the first neuromorphic core when the spike is processed.

15. The medium of claim 13, the instructions when executed by the machine to cause the machine to receive at the first neuromorphic core, during a period of time in which the current time-step of the first neuromorphic core is a first time-step, a first spike from a second neuromorphic core and a second spike from a third neuromorphic core, wherein the first spike occurs in a second time-step and the second output spike occurs in a time-step that is different from the second time-step.

16. The medium of claim 15, the instructions when executed by the machine to cause the machine to, during a period of time in which the current time-step of the first neuromorphic core is a first time-step:
process the first spike by accessing a first synapse weight associated with the first spike and adjusting a first membrane potential delta; and
process the second spike by accessing a second synapse weight associated with the second spike and adjusting a second membrane potential delta.

17. A method comprising:
implementing a plurality of neural units of a neural network in a first neuromorphic core;
storing a current time-step of the first neuromorphic core;
tracking current time-steps of neighboring neuromorphic cores that receive spikes from or provide spikes to the first neuromorphic core; and
controlling the current time-step of the first neuromorphic core based on the current time-steps of the neighboring neuromorphic cores.

18. The method of claim 16, further comprising processing, at the first neuromorphic core, a spike received from a second neuromorphic core, wherein the spike occurs in a first time-step that is later than the current time-step of the first neuromorphic core when the spike is processed.

19. The method of claim 16, further comprising receiving at the first neuromorphic core, during a period of time in which the current time-step of the first neuromorphic core is a first time-step, a first spike from a second neuromorphic core and a second spike from a third neuromorphic core, wherein the first spike occurs in a second time-step and the second output spike occurs in a time-step that is different from the second time-step.

20. The method of claim 19, further comprising, during a period of time in which the first neuromorphic core is set to the first time-step:
processing the first spike by accessing a first synapse weight associated with the first spike and adjusting a first membrane potential delta; and
processing the second spike by accessing a second synapse weight associated with the second spike and adjusting a second membrane potential delta.
